(19) United States
(12) Patent Application Publication
(10) Pub. No.: US 2002/0116266 A1
(43) Pub. Date: Aug. 22, 2002

(54) Method and system for tracking and providing incentives for time and attention of persons and for timing of performance of tasks

(76) Inventor: Thaddeus Marshall, Medford, NJ (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/047,426

(22) Filed: Jan. 14, 2002

Related U.S. Application Data
(60) Provisional application No. 60/261,142, filed on Jan. 12, 2001.
(60) Provisional application No. 60/263,796, filed on Jan. 24, 2001.
(60) Provisional application No. 60/267,374, filed on Feb. 8, 2001.
(60) Provisional application No. 60/277,436, filed on Mar. 21, 2001.
(60) Provisional application No. 60/290,330, filed on May 11, 2001.
(60) Provisional application No. 60/292,402, filed on May 21, 2001.
(60) Provisional application No. 60/308,191, filed on Jul. 26, 2001.

(51) Int. Cl. G06F 17/60

(52) U.S. Cl. 705/14

(57) ABSTRACT

A method for tracking and rewarding the desirable activities, including providing time and attention of individuals, and performing of tasks at desired times, includes providing an incentive rewards program. Individuals, groups, companies, or families are enrolled in a program. Interactions, including in-person sales presentations, viewing of pre-recorded videos, visits to stores and other facilities, and connections to internet websites are recorded. The level of attention provided by individuals during interactions may be measured directly or by proxies, and rewards are provided in greater amounts for greater lengths of interactions and for higher levels of attention. The timing of performance of tasks, including for example early payment of bills, particularly utility bills may be tracked, and rewarded. Points may be redeemed for goods and services, including include entry in a drawing, enhanced likelihood of winning in a drawing, and enhanced prizes in a drawing. Various factors may be included in determining the number of time points awarded, including the time of day and day of week of accumulation sessions, the length of the accumulation sessions, the activities and tasks accomplished, and purchases completed. The formula may also award a varying number of time points depending on the individual's background profile characteristics, including, but not limited to previous purchase history and previous responses to offers of time points. A central program administrator may maintain records relating to the backgrounds of each enrolled individual, and record awards and administer redemption of awards for earned time points.

### RELATED APPLICATIONS

This application claims priority from U.S. Provisional Patent Application No. 60/261,142, filed Jan. 12, 2001, U.S. Provisional Patent Application No. 60/263,796, filed Jan. 24, 2001, U.S. Provisional Patent Application No. 60/267,374, filed Feb. 8, 2001, U.S. Provisional Patent Application No. 60/277,436, filed Mar. 21, 2001, U.S. Provisional Patent Application No. 60/290,330, filed May 11, 2001, U.S. Provisional Patent Application No. 60/292,402, filed May 21, 2001, and U.S. Provisional Patent Application No. 60/308,191, filed Jul. 26, 2001, all of which are incorporated herein by reference in their entireties.

### FIELD OF THE INVENTION

This invention is in the field of incentive reward programs.

### BACKGROUND OF THE INVENTION

Obtaining the time and attention of persons important to a business or other organization is important in the success of the enterprise. The time and attention of potential customers is important for a business, for example. The time and attention of patients is important to health care providers in assuring that patients follow recommended guidelines, as another example. Great effort is expended in creating recorded, interactive, live and combined recorded, live and interactive sales and informational presentations. These presentations may be provided a great number of different venues, including brick and mortar retail locations, offices of potential customers, facilities of health care providers, and by telephone, radio or recorded transmission in the homes, offices, and other locations of potential customers or others whose attention is desired. These types of presentations are increasingly interconnected among each other and with activity that occurs on the internet or on other networks when a connection is established between a device, such as a personal computer running a browser that is operated by an individual who is connected to the internet, and a resource on the internet, such as a website. The activities that have occurred over the internet achieved, or have exhibited a great potential to achieve the reduction and/or elimination of substantial costs, inefficiencies and inconvenience associated with many interactions and other activities involving individuals that also make purchases and conduct other valuable economic activity in physical locations in all industries.

Owners of particular brick and mortar retail locations and other venues, customer interaction, customer physical store locations, particularly within the retail sales and marketing industry, seek to capture the time and attention of individuals by encouraging them to visit physical store locations, perhaps at particular times of the day and on particular days of the week, to remain at those store locations for longer periods of time and to cause individuals to engage in a variety of activities at store locations during that time, including educating and familiarize themselves with products or services examining, assessing and selecting specific products prior to the completion of the purchase process, making purchases, being exposed to the retail store atmosphere and advertisements, engaging in real time conversations with sales representatives and/or performing a variety of other activities within the brick and mortar retail location. In the prior art, rewards programs have been implemented that are designed to track and reward purchases made by individuals at the checkout counter within store locations. For example, in those programs, each individual point of sale device must be programmed so that individuals may be awarded a certain number of points based upon the purchase of merchandise. A variety of problems presently exist relating to brick and mortar based retailing efforts, particularly problems associated with the failure of existing points programs to offer targeted discounts to individuals based upon past purchases and other activity, whether internet-based, remote telephone sales, or offline. Nor have existing rewards incentives programs influenced or otherwise channeled particular individuals with particular purchase histories to particular brick and mortar retail locations where purchases are actually made at particular times of the day or particular days of the week.

A wide variety of tasks, activities and interactions are, to some extent, of greater or lesser value depending upon the particular time within a broader time frame when they occur. There are numerous examples that may be cited involving commercial interactions in virtually every industry wherein the value of the goods or services at issue may vary continuously, or at specific intervals, in part, based upon the scheduled or actual time when they occur. For example, in situations that involve the control of currency, such as the payment of accounts receivable, it is not until the day on which the payment is actually made that the party to the transaction who provided the goods or services and who is entitled to receive that money that is the subject of the transfer obtains control of the money and the benefits that are associated with the time use of that money, including the generation of interest. In the context of accounts receivables, although there have always been penalties in the form of interest charges and other charges that result from the making of delayed or late payments involving single payments and payments that occur over time, there is not and has not been any incentive or awards program that addresses the substantial need to reward the earlier or more timely payment involving accounts receivables, currency transactions and other billing activity. If individuals and business customers can be influenced to make payments in a consistently more timely fashion, the benefits associated with the generation of interest and other value that derive from the time use of money will shift to the provider of the goods or services that were the subject of the payment at issue. Moreover, at present, even though particular individuals and valued customers may make payments consistently on the first day of receipt of the bill over a period of time, those customers are treated no differently at present than those customers who do not pay until the last day prior to the imposition of interest or other penalties. Alternatively, in cases where individuals and customers routinely pay off the entire balance of credit card and other types of revolving credit accounts, the lender derives no benefits associated with high interest rate charges since those individuals do not carry a balance in their accounts. In such cases, those individuals and customers presently have no incentive or reward to pay off the account balance any sooner than the last day before interest or other penalties are assessed. For a provider of services, such as utility service, including telephone, gas and electricity, cable television, credit cards, lenders such as mortgage and automobile loan lenders, and other services, there would be a considerable benefit to moving the average day of timely payments earlier by even a fraction of a day; however, for the individual payer of those bills, no benefit is provided. Beyond transactions involving money, the timing of the scheduling and the timing of the actual occurrence of numerous transactions including the rental of equipment and facilities, the use of resources such as travel facilities, commercial establishments, land and buildings and other activities and interactions will result in a variation in the value of the interaction. While there have been some efforts in the prior art to reward such activities, such as providing discounts if payments of accounts are received by a certain single deadline that usually occurs a certain number of days after receipt of the bill by the individual or customer, these measures and others tend to be highly inefficient and otherwise lacking in the ability to track and reward the specific performance of individuals in paying bills earlier in time individually and on an ongoing basis so as to efficiently encourage and influence the earlier receipt of money.

### SUMMARY OF THE INVENTION

Methods are provided for incentive rewards programs for influencing a variety of desirable behaviors. Desirable behaviors influenced including providing the time and attention of a desired person to live or recorded content, or a combination of live and recorded content, being physically present at a particular location within a particular time frame and/or for a desired length of time, providing referrals of potential customers or other useful information, and engaging in a particular activity at a particular time within a time frame. The particular activity may be payment of bills earlier than before a due date, or engaging in other activity. Points may be provided for a delay or rescheduling of a scheduled providing of services or appointment. Rewards provided may be points that can be redeemed for selected goods or services or any type of goods or services if criteria are met. The rewards may include entry in a lottery or drawing, enhanced winning prizes in a lottery or drawing, or enhanced likelihood of winning a prize in a lottery or drawing. The rewards may be available for a single occurrence of the desired activity, or the person may be required to repeat the desired activity one or more times. The person may be required to combine multiple desired activities in order to obtain rewards, such as engaging in a purchase in order to receive points, or to permit points to be redeemed, for providing attention to content, or for a visit to a particular store or other location. Combinations of such activities, or repeating of such activities, may provide enhancements of existing rewards, rather than being a condition for rewards. Numerous combinations of desired activities may be designed.

In one aspect of the invention, a method is provided to track and reward time and attention in viewing content. The content may be a live interaction with a person, such as a salesperson, and/or recorded content of any nature, presented over any medium. The tracking of time may refer to duration of interactions, time of day, day of week, and date. The tracking of attention refers to determining the level of attention provided by the person during the interaction. The interaction may take any form, including accessing a resource, such as a website or a database of recordings, over a network, such as a voice telephone network, the internet or an intranet or local area network, face-to-face interactions between a human offeror of rewards and a potential recipient, physical visits to a specific location where the rewards are offered at pre-determined times or otherwise, and other forms. An interaction may be provided by viewing of recorded content and then responding, by telephone or other communication, either during or after viewing the content. An interaction with content may be referred to herein as a time points accumulation session. The rewards will be referred to as time points, although it will be understood that rewards by any name may be substituted for time points. An interaction in which time points may be accumulated will be referred to as a time points accumulation session. The level of attention demonstrated by individuals during time points accumulation sessions may be tracked in a variety of ways including by tracking the timing and timeliness of responses provided by the recipient of the time points offer or by the participant or representative of the participant offering the time points.

The method will typically involve the enrollment of the individual in a program. The term individual will be used here to designate any person, organization or group that is enrolled in an incentive awards program. Enrolled individuals may include entire businesses, departments, families or other groups. It is anticipated that under a variety of circumstances, targeted individuals will be enrolled by the offeror of time points. Upon enrollment, an individual background profile is created in a suitable database. Enrolled individuals may then engage in interactions. The commencement of the interaction may be initiated by the individual, by indicating the commencement in any suitable manner, or by a representative of the person or entity seeking to offer the reward. Upon receipt of information identifying the enrolled individual, the interaction will be recognized as an accumulation session. During an accumulation session, the individual may accumulate time points. The level of attention demonstrated by individuals during accumulation sessions or suitable proxies for attention may be measured and recorded. For example, the individual may be required to indicate attention by responding to prompts included as part of an interaction carried out by remote communications, such as computer based or telephone based interaction, by devices that are present in a physical commerce location that are designed to identify the individual, or otherwise. Alternatively, a representative of a program administrator or a participant may record information such as the point at which unscheduled interruptions interfere with the interaction between the representative and the targeted individual. In this context, the number of interruptions and the degree to which the interruptions are deemed to interfere with the interaction is assessed by the representative and is deemed to represent the level of attention demonstrated by individuals during accumulation sessions. The interaction or accumulation session may be completed by affirmative act of the individual, by affirmative act of the representative, or automatically based on algorithms such as a failure to respond within a suitable time limit. Upon completion of the accumulation session, data acquired during the accumulation session is evaluated according to algorithms to determine if rewards, or points, are to be credited to the individual, and if so, the number of time points to be awarded. A wide variety of algorithms may be developed. In general, the greater the duration of the accumulation session, within suitable and appropriate limits depending on the particular circumstances, the greater the number of time points will be credited. Similarly, the higher the level of attention demonstrated during accumulation sessions individually and over time, the greater the number of time points will be awarded. This will create an incentive on the part of individuals who are targets of offers of time points to provide their undivided time and attention and to do so with an incentive to have fewer interruptions. If fewer or no interruptions are recorded during accumulation sessions, the targeted individuals will be provided incentives so as to entitle those individuals to receive additional future offers of time points more often and at a higher rate of accumulation. Proxies for the level of attention demonstrated by individuals during accumulation sessions may include the absence of recorded interruptions during the sessions, the timeliness of responses to prompts during the sessions, the accuracy of responses to queries designed to demonstrate the level of attention to subject matter of the interaction demonstrated by the targeted individual, and other items. Points may be redeemed for items of value in accordance with formulas that may be developed.

A method of providing rewards based upon the time of day, the day of the week that purchases and other tasks and activities are accomplished at particular brick and mortar retail locations and elsewhere by tracking the contact time established by individuals and a network resource through a kiosk or similar communications platform within brick and mortar retail locations or other venues and based upon purchases and other activities conducted by individuals and includes receiving identification information from a client, correlating received identification information with stored identification information, assembling relevant factors so as to create a customized list of time points incentives offers related to specific products and services, printing of that information on a sheet of specifically colored paper that enables sales representatives to readily identify those individuals who possess a specific color of paper are preferred customers who are present within the brick and mortar retail location or other venue at a point in time that is within the most desired period of time specified by the client in a specific offer of time points received by the individual in advance of the actual visit and that is one of a number of colors of paper that enable client employees to identify certain characteristics of the individuals who are present within brick and mortar locations or other venues. The other colors of paper that are made available to individuals are designated to represent any one of a number of categories of customer for purposes of enabling client to better serve preferred customer with limited human resources that may be available at a given period of high customer volume. The other colors may indicate that an individual is a customer who is a preferred customer, but who is not present within the brick and mortar retail location or other venue at a point in time that was specified by the client in a specific, targeted offer. The color of paper assigned to an individual will reflect that level of priority of service assigned by the client to that individual based upon a number of factors including the time of the visit to the brick and mortar location or other venue, assigning a value or code to the purchase receipt that the individual receives at the check-out line and which the individual proceeds to enter at the kiosk or other location, at which time points are awarded based upon the purchases, as well as other activity or tasks completed by the individual within the brick and mortar retail locations, generally and while interacting with the kiosk or other platform within the premises, calculating points and awarding a specific number of points based upon purchases and other activities conducted by the targeted individuals as detected and recorded by the network and based, in part on the specific time of day, the specific day of the week and the length of the contact by individuals with brick and mortar retail locations, if applicable, as well.

A method of providing a rewards program based upon the contact between individuals and a client's network resource located within a kiosk or other platform within a brick and mortar retail location, including enrolling an individual in a rewards program by obtaining individual background profile information and storing that information in various forms at the location of a program administrator, requiring that the identification of the individual be provided in a fashion that is in conformity with resource-imposed requirements, referencing stored information, recording the information that is captured as a result of the contact with individuals including, at the very least, the specific purchases and other tasks and activities that occurred and were recorded in some fashion within the brick and mortar retail location or other venue including at the point of sale, the time of day, the day of the week and the length of the established physical contact by individuals with particular brick and mortar retail locations, if applicable, as well the forwarding of the recorded information to the program administrator, the updating of the stored individual background profile information that may be maintained at the location of the program administrator and/or the resource, calculating the number of time points that were earned as a result of the accumulation session based, in whole or in part, on the stored individual background profile factors, together with a formula that is selected by the participant; and permitting redemption of the earned time points for items of value as permitted by the particular resource wherein the time points earning session takes place.

A method is provided to track and reward the time and timing of the occurrence of tasks, activities and other interactions. The time period that is involved may be a particular time or a range of time during a particular day of the week and a particular date. The tasks, activities and interactions may take any form, including the payment of accounts receivable, the use, rental, occupation and exploitation of a resource, including airline seats, hotel rooms, car rentals, equipment rentals, or the use of other services involving the use or provision of resources such as personnel, electronic resources, such as a website or a database of recordings of particular content or presentations, over a network, such as a voice telephone network, the internet or an intranet or local area network, face-to-face interactions between a human offeror of rewards and a potential recipient of them, physical visits to a specific location where the rewards are offered at pre-determined times or otherwise, and other forms. A member of a health maintenance organization or other health care provider may be rewarded if a scheduled follow up visit occurs as scheduled or otherwise within a certain time frame. The individual members may be offered incentives for visits to a health care provider in this manner by health management organizations as an additional incentive to cause HMO members who fail to conduct follow up visits to participate so as to receive proper medical care on a timely basis, the care including both preventative or other routine care and more urgent care. This is accomplished through a program wherein the award of time points according to formulas selected by the offeror of time points. The program may draw a distinction between the accumulation of time points and the earning of time points. Earning of time points refers to points that may be redeemed for products and/or services, while accumulation refers to time points that are subject to fulfillment of a condition before being capable of being redeemed. The accumulation of time points may be available for a particular activity at a particular time. In addition, in certain instances, some or all of the accumulated points may be earned immediately and in other instances, some of the accumulated time points may only be earned in connection with later activities at a later time or date, particular or otherwise.

In a program to provide incentives for the timing of tasks, in general, the greater the importance or desirability of the timing of the desired tasks, activities or interactions, the greater the number of time points that may be awarded, within suitable and appropriate limits and depending upon the particular circumstances. This will create an incentive on the part of individuals who are targets of offers of time points so as to encourage them to schedule their activities so as to accommodate the scheduling preferences of the offerors, on an individual and ongoing basis. For example, the individuals may make payments of bills by certain dates, between certain dates and within certain periods of time that may be consistently nearer to a targeted date or otherwise more quickly than standard terms of agreement, or more quickly than would otherwise occur. The individuals may schedule use of facilities, such as rental of equipment, hotel and motel rooms, banquet facilities, and automobiles, to low demand times desired by offerors. The individuals may schedule regular shopping, appointments with service providers, such as personal care providers, such as barbers, or health care providers, to relatively low demand times of the day, days of the week, or days of the month or days or months of the year. The individuals may agree to rescheduling of appointments. All of these accommodate the needs or desires of the service providers in the time of the occurrence of tasks, activities and interactions. The time points that are earned may be redeemed for items of value in accordance with formulas that may be developed and tailored to satisfy particular needs and situations.

In one aspect of the invention there is provided a method for providing an incentive for early payment of invoices by providing any of entries in a lottery, enhanced prizes for winning in a lottery, or enhanced likelihood of winning in a lottery, based on the timeliness of bill payments. In such method, the enhanced prizes or likelihood of winning may be based on past performance. Alternatively, a rewards program may be provided in which early payment results in the earning of points or the equivalent, which points may be redeemed for entries in a lottery, enhanced prizes if the entrant wins, or an enhanced likelihood of winning. In one aspect of the invention, there is provided a rewards program relating to bill payments and other invoices, comprising the steps of enrolling an individual who periodically pays service provider bills and/or other invoices having a payment due date in a rewards program; recording the date of payment of each service provider bill or invoice; providing the individual with an opportunity to enter in a lottery game; and determining the size or value of a prize for winning available in such lottery game based on one or more factors, including the recorded dates of payment, the amount of the individual bill, the average amount of the bills paid by the particular customer for a specified period of time prior to the lottery win and other factors. In one aspect of the invention, the individual may be first enrolled in a program, the individual may accumulate points or the equivalent through the submission of bill payments in a required and timely fashion, and then may earn and redeem points for chances in a lottery. In another aspect of the invention, the timing of payment of one or more bills is recorded by the service provider or another entity providing services related to the program, and the individual is provided an opportunity to enter in a lottery. The chance of winning the lottery or the nature or value of the prize may be based in part on the recorded dates of submission of bill payments. In one aspect of the invention, the individual is provided an opportunity to enter into an instant-win type game (of which scratch-and-win games are an example) in which the prize or chance of winning is based in part on the recorded timing of bill payments that may have been made up to that point in time, as well as a potentially broad range of factors. The service provider bills or invoices may result from the provision of goods and/or services such as utility bills, including bills for household use of utilities, such as electricity, gas, water, telephone, cable television, satellite television, and internet access and others. The service provider bills or invoices may be for a good or service, and a prize for winning the lottery may be the provision of the good or service at a reduced cost or at no cost for a prescribed period of time, as well as other potential benefits including cash prizes. The calculation of the size or value of the lottery prize or reward may be based in part on the measured number of days in advance of the applicable bill or invoice due date that the bill or invoice payment was received by the service provider, individually and over time.

An instant-win type lottery game is one in which the player immediately learns whether the player has won that aspect of the lottery program. By immediately, it will be understood that there could be a delay on the order of seconds or longer during a lottery conducted by remote connection, such as through an Internet connection or by some other means. An example of such a game is a scratch-off game. In such games, a card is printed indicating, directly or indirectly, whether the player is a winner and the prize that is awarded. An example of how the instant-win game may be deployed involves applying an opaque layer over the portion of the card that indicates whether the player is a winner and preferably the type of prize they have won. This opaque layer may be on the actual bill statement itself. The player can readily scratch off the layer, using a coin, for example, to view whether the player has won. Instant win games may also be played by communication with a game administrator's computer, such as through a connection to a website.

In one aspect of the invention, there is provided a method for rewarding an individual with points that constitute or can be converted into entries in a lottery or sweepstakes drawings or that are tracked and deposited into a loyalty account, or that are both employed in connection with sweepstakes entries and, if the individual does not win in the sweepstakes, deposited into a loyalty account. If the individual accomplishes any one of a number of additional activities including making purchases online, offline or over the telephone, the individual receives points (or the equivalent) that are deposited directly into the loyalty account established to receive previous unsuccessful sweepstakes entries. The points that an individual may accumulate in other ways may entitle the individual to an enhanced or additional prize either as a reward for loyalty, or if the individual is successful in the sweepstakes. In addition, accumulated points in the loyalty account may be redeemed for free or discounted services.

### BRIEF DESCRIPTION OF THE FIGURES

FIG. 1 is a flow chart depicting a high-level process flow in a method according to the invention.

FIG. 2 is a flow chart depicting a process flow in a method according to the invention.

FIG. 3 is a flow chart depicting a process flow relating to a method of selectively providing customer service according to the invention.

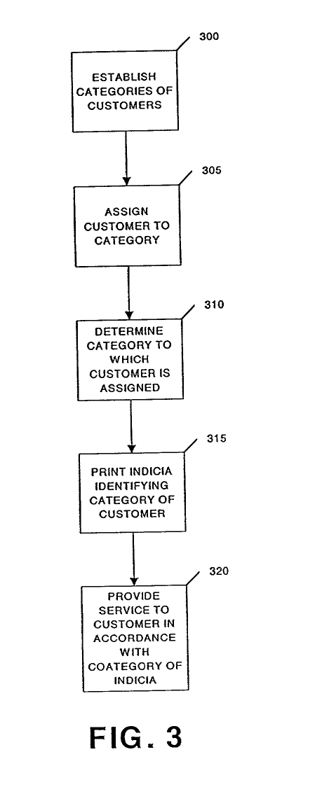

FIG. 4 is a schematic depiction of devices employed in a method and system of the invention.

FIG. 5 is a flow chart depicting a process flow in the calculation of credits in a method according to the invention.

FIG. 6 is a flow chart depicting a process flow in the calculation of credits in a method according to the invention.

FIG. 7 is a flow chart depicting a high-level process flow in the redemption of credits in a method according to the invention.

FIG. 8 is a flow chart depicting a detailed process flow in one manner of redemption of credits in a method according to the invention.

FIG. 9 is a flow chart depicting a detailed process flow in an alternative manner of redemption of credits in a method according to the invention.

FIG. 10 is a flow chart depicting a detailed process flow in an alternative manner of redemption of credits in a method according to the invention.

FIG. 11 is a flow chart depicting a process flow in an alternative embodiment of the invention.

FIG. 12 is a flow chart depicting a process flow in an alternative embodiment of the invention.

FIG. 13 is a flow chart depicting a process flow in an alternative embodiment of the invention.

FIG. 14 is a plan view of an article used in a method of the invention.

FIG. 15 is a flow diagram depicting a process flow in an embodiment of the invention.

### DETAILED DESCRIPTION OF EMBODIMENTS OF THE INVENTION

In the following description, the operation of exemplary incentive rewards programs will be described. The incentive programs require enrollment of individuals. Enrolled individuals accumulate time points by engaging in activities specified by the programs. A wide variety of desirable activities may be rewarded by the described programs. An account associated with an individual is provided with accumulated time points when a desired activity is performed. Time points for differing activities may be aggregated in one account, if desired. When criteria specified by the program are met, some or all of the time points in an account are deemed earned. When time points are earned, the time points may be redeemed for products and/or services of value. A wide variety of rewards may be offered in connection with the described programs. Optionally, time points may be maintained in the account to have available for future rewards.

An individual or a group of individuals who may maintain a single commonly accessed account enroll in the program. The individual or a group of individuals who maintain a single commonly accessed account will hereinafter be referred to as an “individual” in this specification. It will be understood that the term individual in this context may apply to an account accessed by more than one individual. It will also be understood that the rewards programs described may involve the awarding of time points or credits to an entity based upon the activities of more than one individual. For example, a business organization may be able to accumulate, earn and redeem time points or credits based upon the time and attention, as well as the tasks and activities of its individual employees, partners, or other representatives. In addition, families may be able to participate based on the time and attention provided by any member of the family, or selected members of the family meeting selected criteria.

The program may be maintained by a program administrator. Multiple participant organizations may engage in interactions with individuals, while the program administrator engages in various tasks as described below. Alternatively, the program may be administered by the same organization that engages in the interactions with individuals. In this circumstance, the program administrator may be a computer system maintained by the same organization. It will be understood that the rewards program will be implemented by suitable computer software that runs on a computer system of a program administrator, and by computer software running on computer systems of program participants, as described below. The computer software is stored on a storage medium, which may include, by way of example, fixed disk, CD-ROM, magnetic tape and optical disks. The computer program or programs of the invention may be transmitted as signals between computers over networks. The computer programs contain instructions that cause processors to perform the steps as described in this specification. The processors may be any suitable processors.

A suitable database program may be used to organize and store information relating to individuals and participants. The database may include conventional identification information, such as name, addresses, and other contact information, and information regarding the history of performance of desired activities. Specific examples of desired activities are set forth in detail below. The database may also include individual background profile information, as explained below, including occupation, income, hobbies and other useful information.

A variety of information about the past performance by the individual of desirable activities is recorded, and may be incentivized by the program. Such activities may include purchases, store visits, attending in person or remotely sales presentations, providing blood donations, cash or other donations, engaging in volunteer activities, or a range of other activity which may be desired. The program may be used to enable electric utilities and other companies that experience peaks in demand to steer individual customers to consume electricity or other services at off-peak times, if desired. The individuals who participate in the bill payment lotteries, as explained below, may be able to earn more points, earn bigger prizes or receive other important benefits based upon the degree to which they have demonstrably altered their energy consumption patterns as required by the utility provider and program participation requirements. This method may be used to accommodate the tracking and rewarding of individuals with particular blood types who donate blood at particular times and at particular locations so as to balance demand for blood as part of a blood drive sponsored by service providers, hospitals or other entities. In awarding time points to individuals based upon blood donations, a variety of factors may be taken into account including the frequency of blood donations, the quantity of blood donations, the timing of the donations in accordance with seasonal fluctuations in need, the length of time involved in completing the blood donation procedures, as well as the quality or type of blood donated, with a greater number of time points being accumulated and earned for rarer blood types or other special qualities. Individuals may be rewarded for a duration, such as a duration of telephone calls using a certain calling card or service provider, a duration of time on a list of available volunteers, a duration of time being listed as a donor list of any kind including blood, marrow or organ donation, and length of time of performing volunteer services. Individuals may be rewarded for participating in a survey, conducted on-line, by telephone, in person (such as a focus group), or by filling out a physical form and mailing the form or leaving the completed form at a business establishment. Other activities may include providing incentives for faster use of prepaid phone cards or any other type of prepaid services. The method may be used to reward the timing of the performance of a wide range of tasks and activities, including capturing the time and attention of targeted individuals for a variety of purposes including participating in an advertising presentation of a pre-determined, measured period of time that may be offered by a telemarketer over the telephone, listening to and participating in an advertising presentation offered by a telemarketer at a particular time and at a particular website and with a sales representative within a particular retail store location or within a range of other venues and settings.

Other activities that may be rewarded include meeting scheduled appointments. This may be used to provide incentives to HMO members to make appointments for routine medical examinations, to attend follow up visits after an illness, to continue through a course of physical therapy or other treatment, and other desirable activities. The voluntary rescheduling of appointments may also be rewarded in a method and program of the invention. For example, a service provider, such as a health care provider, home repair or maintenance provider, or other provider, may offer points for rescheduling of an appointment, if, for example, the service provider is unable to make the appointment, or the service provider desires to accommodate another customer who is not flexible as to appointments.

A specific example of a desirable activity is the review of pertinent information relating to a medical condition in connection with a visit to a health care provider's office. An individual may be provided with content, in the form of printed text or graphics, or a video or audio presentation, and offered points, or other program rewards, for attending to the content. Verification may be assured by monitoring the individual directly by staff, by a questionnaire filled out while or after the content is reviewed, or other suitable means. Such content may be provided on such topics as caring for chronic diseases and conditions, general information on a condition or disease that the individual has or may have, or any other topic desirable to an insurer, HMO, or health care service provider.

Opportunities to obtain program points by viewing content may be provided at any time that the individual is required to wait for a service, such as for a delayed airplane or other transportation departure, or delays in scheduled health care provider or other appointments. The individual may be provided with content that the service provider wishes the individual to see, or content in the nature of advertising from third parties.

In the example of payment of periodic bills, the timing of payment by a subscriber is recorded. The timing of payment information recorded is typically date of payment, with the information ultimately used being the number of days prior to the due date of the payment that the payment is actually posted. This information about performance of desired activities is preferably recorded in a database, as noted above. The database preferably contains information such as the name, address and the utility's account number of the individual, and, associated with each individual information pertaining to desirable activities, such as bill payment history. Depending on the type of activities, the information stored in the database may include specific information, such as dates and times of store visits, amounts of purchases, dates of blood donations, payment data information, or various values derived from that information.

In one aspect of the invention, after performing a desired task, the individual is provided an opportunity to participate in a lottery. This may be provided, for example, in connection with utility billing. The opportunity may be provided after, for example, paying a utility bill at least a specified number of days prior to the due date a specified number of times consecutively, or a specified number of times within a certain number of billing cycles or time period. For example the opportunity may be provided to all customers who pay their electric bills at least seven days before the due date at least six times in twelve billing cycles. This lottery may be an instant-win type game. An instant-win game is one of a general class of lottery games in which the individual is informed promptly after taking some action to participate, as to whether the individual has won. The opportunity may be provided, for example, by including a scratch-off type game card with a bill for services, or with other materials sent by postal mail to the individual. If the individual is being awarded the opportunity following providing time and attention to a sales presentation, a card may be provided to the individual at the time of completion of the presentation, assuming that requirements of time and attention have been met. Of course, such a scratch-off card may be delivered to the individual in a separate mailing or otherwise. The subscriber may be provided an opportunity to participate in an instant-win game which is accessed over a computer network. For example, an individual may be given, by mail or otherwise, a code or unique website address to obtain an opportunity to play an instant-win/scratch and win type game at a site on the world wide web.

In a program, all activities may be rewarded directly by the award of points. Alternatively, different activities may provide different types of incentives. For example, points may be awarded for early payment of periodic utility bills, and enhancements to the number of points and/or to the prize for a different activity, such as attending to a survey or sales presentation, or providing referrals. In such a program, individuals may choose to delay redeeming points earned through early payment of utility bills by entry into a lottery until they have provided a referral, if the referral improves the prize or award for winning, or improves the likelihood of winning. This feature also creates a greater incentive for individuals to provide more frequent performance of the secondary activity, such as surveys or providing referrals. It will be understood that any activity may be selected as a primary activity which results directly in the award of points, and any other activity may be selected as a secondary activity which results in enhancements of points awarded as a result of other activities.

One activity, such as early payment of utility bills, may be a prerequisite for entry into a program whereby points may be accumulated through a variety of activities. A combination of disparate activities may be a prerequisite for redeeming prizes, or for enhanced prizes or different prizes. For example, an individual may accumulate points for both early payment of utility bills and providing attention to a sales presentation, but must participate in both in order to earn and redeem points for awards.

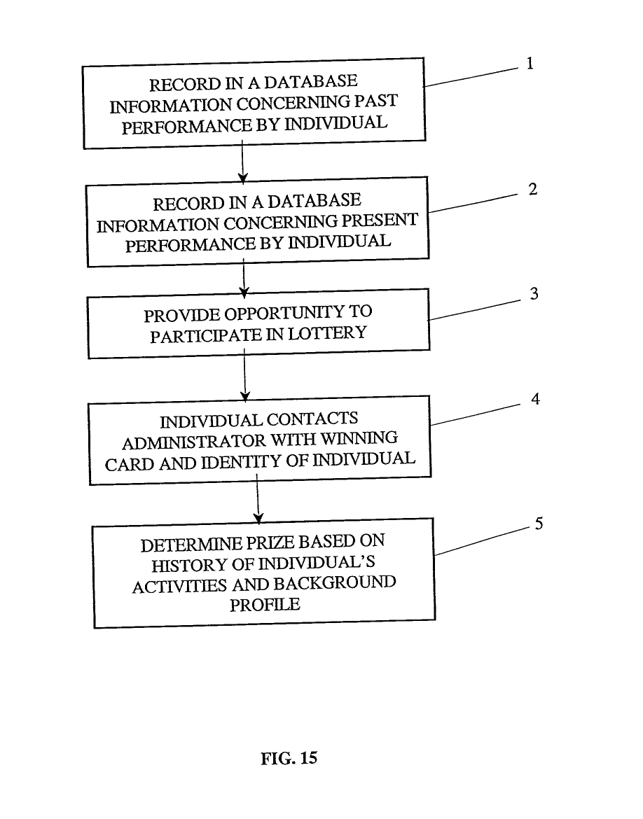

The rewards available, through a lottery or for direct redemption, the chances of winning in a lottery, or the number of points awarded for a given activity, may be enhanced based on information about the individual's past performance. For example, the number of points awarded for payment of a utility bill at least five days early may be greater for an individual who has paid such bills at least that early for six consecutive billing cycles, than for an individual who is paying such a bill early for the first time, or did not make such a timely payment in the most recent billing cycle. Alternatively, if the reward is an entry in a lottery, the winning prize may be greater for the individual who has provided the early payment a sufficient number of consecutive billing cycles. The use of an algorithm of this type further enhances the participation in the program. This is illustrated with reference to FIG. 15, where block 1 indicates the step of recording in a database information concerning past performance by the individual. This information may be information recorded in the ordinary course of business, such as payment dates, or information specific to a program. The present performance by the individual is then recorded, as indicated by block 2. The opportunity to participate in a lottery is provided if the prerequisites are met based on present and past performance, as indicated by block 3. The individual contacts the administrator, such as a third party engaged by a utility to provide a lottery program, by any of the methods described in this application, as indicated by block 4. The prize is determined using an algorithm including past performance and information in the background profile, as indicated by block 5. In general, greater past performance will result in a more valuable prize, and information in the background profile indicating that the individual is likely to engage in additional desired tasks or activities may result in a more valuable prize.

Either before or after providing the individual the opportunity to participate in the game, the prize may be determined based on an algorithm in which the information recorded in the database as to desirable activities by the individual plays a part. In general, in the algorithm, the greater the desirable activity, such as number of store visits, value of purchases, frequency of blood donations within proper limits, or the length of time before the stated due date that bill payments were historically received, the larger or more valuable the prize. The algorithm that determines the value or type of prize may also be based on information from an individual background profile of an individual, as described, for example, in my copending U.S. patent application Ser. No. 09/722,904, filed Nov. 27, 2000, which is incorporated by reference herein. Such information includes occupation, income, hobbies, interests, information relating to prior purchases by the individual, age, family members, employer or type of employer, health information, and other information that may be of interest. For example, an individual who is reflected in an individual background profile to be a frequent purchaser of expensive computer hardware may be eligible for a greater prize based on three visits to a computer store, while an individual who has a long history of visiting stores with few or no purchases may be eligible only for a standard prize.

With certain types of instant-win/scratch and win games, there will be an option to permit the adjustment of the probability of winning based in part on the recorded history of the performance of desirable activities, such as the timing of the receipt of bill payments, from the individual, as well as the individual's individual background profile. For example, in instant-win game that is accessible over the Internet, if the individual's identity is known at the time that the game is played, it will be possible to access the database of desirable activities, and the individual background profile, and adjust the probability of winning using an algorithm in which information in the database and/or in the individual background profile is employed as one or more inputs.

In a scratch-off or other instant-win game that involves a preprinted card, it is not practical to adjust the individual's probability of winning at the time of playing. Rather, the individual may be required to contact the lottery administrator with proof of possession of the winning card and provide information identifying the individual. The lottery administrator then determines the prize, the value or identify of which may be determined using an algorithm based on the history of desirable activities and optionally the individual background profile associated with the identity of the individual. The prize is then delivered to the subscriber in any conventional or new manner.

As an alternative to an instant-win game, the individual may be provided an opportunity to play in a game which requires some response by the individual, but does not immediately notify the individual as to whether the individual has won. For example, the individual may be required to communicate with a game administrator by mail, telephone, Internet communications, or other type of communications, to enter the lottery, and then await a response that may be conveyed in a variety of forms including within the next bill statement, at a particular website, or in some other fashion. The prize or probability of winning may be adjusted here as described above.

In an alternative embodiment, the lottery may be offered as an incentive to subscribers to utility service or other bill payers without being directly related to the history of desirable activities, such as the timing of the bill payment history.

By way of further example, rewards may be made available in connection with accumulating points for delays at a location associated with a service, such as a health care facility, an airport, or other physical location. The location may also be a retailer where individuals are routinely caused to wait for a variety of services or interactions including meeting with a sales representative. Such retailers may include automobile dealers and retailers of other high-priced items, such as certain jewelry and electronics retailers and others.

There will now be described programs in which points are earned. In this application, the items that are awarded may be variously referred to as credits, awards, or time points. It will be understood that these terms are interchangeable and describe any type of award, even if those are not described as time points.

For instance, in awarding time points to individuals based upon blood donations, a variety of factors may be taken into account including the frequency of blood donations, the quantity of blood donations, the length of time involved in completing the blood donation procedures, as well as the quality or type of blood donated, with a greater number of time points being accumulated and earned for rarer blood types or other special qualities.

Electric service providers may also provide time points for use of interruptables. At present, electric utilities provide a discounted rate for customers who agree to have their service interrupted up to a maximum time per time interval, such as 100 hours per month. This permits the utility to manage demand at times of peak demand. However, there is no incentive to agree to interruptions beyond the stated maximum. An electric utility, or in principle other service provider, may provide points based on the duration of interruptions. Consumers will then have an incentive to accept interruptions in excess of the agreed maximum. This feature may be used in combination with the award of time points in exchange for shifting consumption from periods of peak demand to periods of lesser demand.

Other desirable activities which may be awarded include providing of referrals. Points may be awarded for providing of information as to individuals who may constitute potential customers. The award of points may be made contingent on the verification of the referred information, on the referred persons actually making a purchase, or at least attending to a sales presentation, or other criteria. The success of the referral may also be recorded, and points awarded based on the success of the referral. Success items may include whether the address and other verifiable information was accurate, and the activities engaged in by the referred individual or entity. Activities engaged in of interest may include participation in a rewards program, making payments early, actual purchases, participating in a free trial of a product or service, attending to presentations in some form, providing donations or volunteer services, or other activities. The number of referrals may be capped on a per unit time basis or in some other manner to prevent the system from being flooded with doubtful referrals. Persons who provide referrals that are not successful, such as not being verifiable, or an unusually high percentage not engaging in transactions, may be prohibited from obtaining points for future referrals.

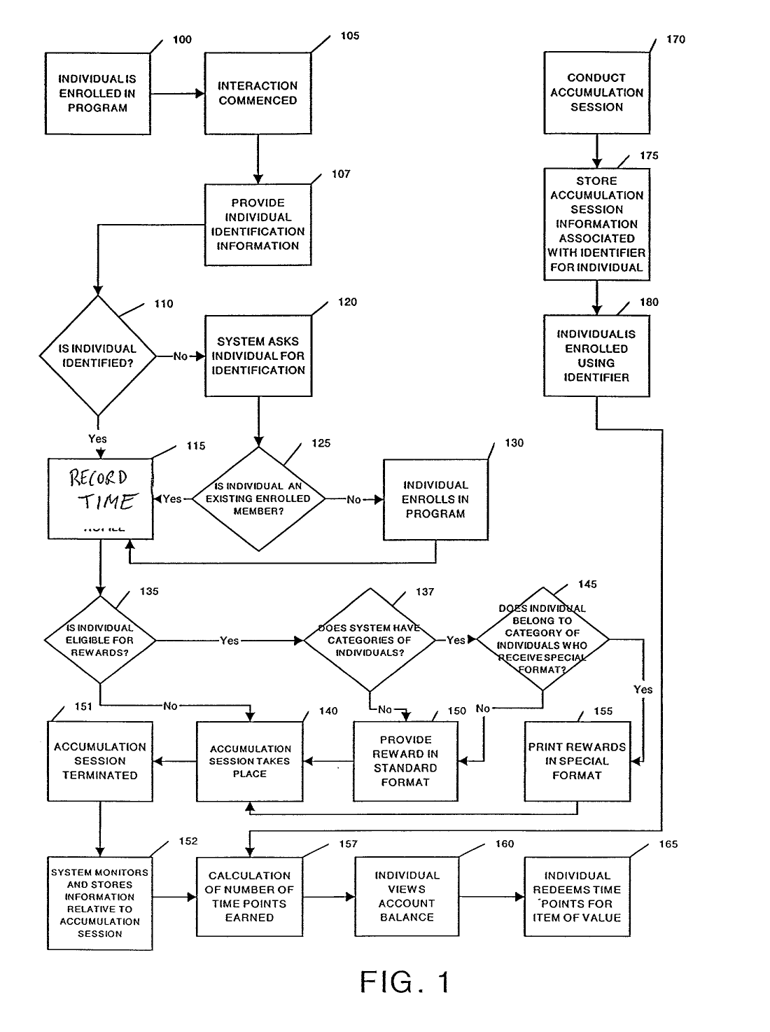

Referring to FIG. 1, the step of enrollment is indicated as block 100, labeled INDIVIDUAL IS ENROLLED IN PROGRAM. The step of enrollment may be the first step in the process, as indicated by the process flow commencing at block 100. Alternatively, an accumulation session may be conducted, or other activity for accumulation of points may be engaged in and recorded, prior to enrollment, as indicated by the process flow commencing at block 170 and explained below. As part of the enrollment process, the individual creates an individual background profile that is stored at a suitable database location. This may be done in any suitable manner. For example, if enrollment occurs via a connection from the individual's computer (a client), to the web server maintained by the program administrator or participant, a web-based form may be provided via the network to the client's browser and displayed for the individual. The device used for display need not be a computer of the individual, but may be a handheld or other device, internet appliance, or computer, either belonging to the individual, to the program administrator, to a participant, or to a third party. By way of further example, a form may be presented to an individual in connection with a physical interaction involving the individual. A physical interaction involving the individual is any interaction in which the individual is physically present and/or conducting a machine-based interaction involving devices, the specific location of which is dictated by the other party in the interaction. By way of further example, a form may be presented to an individual at a computer or terminal located at a physical commerce location. A paper form may be completed by the individual or by someone transcribing information for the individual and the information subsequently provided to appropriate computer systems through data entry, optical character recognition or other suitable techniques. The form will have directions and blocks for providing valuable background information and for completing forms that are necessary to establish a unique individual background profile for the new program member. The individual's browser transmits that information across the network to the system. The individual background profile contains various information relating to the individual, as noted above. The individual background profile may, depending on the type of activity, also contain information to identify the individual when the individual interacts at a physical commerce location. For example, the system may issue the individual a unique alphanumeric identification code. If the individual is enrolling at a physical commerce location, a card with magnetically coded information uniquely identifying the individual may be furnished to the individual. A printable bar code may be furnished to an individual enrolling over a network.

The term physical commerce location designates any location where an individual may engage in a commerce related interaction in person, including retail stores, showrooms, shopping malls, airports, repair facilities, offices of professionals, entertainment locations such as theaters, theme parks, amusement parks, educational gatherings, museums, zoos and a variety of other settings.

In one aspect of the invention, criteria are developed for the award of credits or points, or other items of value These criteria may be selected by each participant for those interacting with the participant. These criteria may vary for different programs. For example, these criteria may include the commencement of an interaction of a particular type, whether of pre-determined length of time or not, at a particular time of day, a particular day of the week, or on a particular date or within a particular time frame. For example, the type of interaction specified may involve viewing material on a website via an internet connection, possibly at a certain time of day, attending a presentation at the individual's place of business, home or any other location by a representative of the participant, visiting a particular physical commerce location designated by a participant, listening to a presentation made by telephone, attending a live or previously recorded presentation, responding to questions posed by a representative of the participant in any context wherein the time and attention of a targeted individual or group of individuals is desired to be captured or other type of interaction. The criteria may include certain values contained in the individual background profile in order to qualify for the awards of credits or time points. Such values may include information regarding prior purchases, prior web surfing habits and related information, age, income, residence, family information, hobby information, occupation information, and other information. The information contained in the individual background profile may then be used to notify the individual of the availability of the award or other item of value. Notification may be by e-mail, postal mail, telephone, or other appropriate technique.

For example, in the context of a visit to a physical commerce location, offering time points or rewards contingent on a time of day or day of week, or based on past purchase information or interests, will result in enabling the brick and mortar retail location to more effectively control the flow of specific inventory at brick and mortar locations, as well as to more effectively address issues associated with customer retention and loyalty. For example, a retailer that is a participant in the system may designate that targeted individuals above a threshold income level who are recorded as entering one of the retailer's store locations within a certain window of time and on a designated day will be awarded time points. Alternatively, the award may be available on a particular day of the week within a certain window of time over a particular period of time. For example, if a retailer maintained an excess of cordless drills in the inventory of a specific brick and mortar retail location, the retailer would send a targeted offer of time points to individuals with a history of making purchases of carpentry related products as they would be likely candidates to be interested in purchasing cordless drills. The offer of an enhanced number of time points in order to create an incentive for such targeted individuals to physically entering into particular retail locations that maintain an excessive numbers of cordless drills would create an increased likelihood of selling the cordless drills, thus, causing a positive effect on inventory control. Similarly, such individuals could be invited to access an e-commerce website where the cordless drills could be purchased in order to receive a specific offer of time points as a purchase incentive or in order to purchase the cordless drills at a specially discounted price. In one aspect of the invention, criteria are developed for the award of credits or points, or other items of value. These criteria may be selected by each participant for those interacting with the participant. These criteria may vary for different programs. For example, these criteria may include number of days before a deadline for a selected action, such as payment of an invoice or performing a service call, the time of day of an interaction, such as a visit to a physical commerce location, or the date of use of a service, such as car or equipment rentals. For example, the type of interaction specified may involve visiting a particular physical commerce location designated by a participant, the time of day or day of week of making a purchase, the time of use of rental equipment or facilities, such as hotel rooms, rental cars, airline tickets, the rental of equipment or other items, spending a measured period of time listening to a presentation made by telephone, attending a live or previously recorded presentation corresponding to questions posed by a representative of the offerors. In addition, the purchasers of services may also award time points as an incentive to individuals or businesses who meet or exceed applicable timeliness standards in relation to the performance of tasks, activities and interactions. For example, tenants may provide points to landlords for prompt completion of tasks such as providing repairs and snow removal. An individual or business that consistently pays the bill for the performance of services immediately upon the receipt of the same may earn time points so as to reward them for performing the task of paying the bill sooner than might otherwise occur absent an incentive or reward for doing the same. The criteria may include certain values contained in the individual background profile in order to qualify for the awards of credits or time points. Such values may include information regarding prior purchases, prior web surfing habits and related information, age, income, residence, family information, hobby information, occupation information, and other information. The information contained in the individual background profile may be used to notify the individual of the availability of the award or other item of value. Notification may be by e-mail, postal mail, telephone, or other appropriate technique.

For example, in the context of a visit by an individual to a physical commerce location, the offer of time points or other rewards contingent upon the interaction occurring at a particular time of the day or a particular day of week, or based upon the past purchase history of the individual or other personal information including other interests, will result in enabling the operator of physical commerce locations to more effectively control the flow of specific inventory at physical commerce locations, as well as to more effectively address issues associated with customer retention and customer loyalty. For example, a retailer that is a participant in the system may designate that targeted individuals above a threshold income level who are recorded as having entered a particular retailer's store locations within a certain window of time and on a particular day will accumulate a specified number of time points, the earning of which may be tied to certain criteria related to future activities at that location or at other physical locations or in other types of interaction, such as through a computer or telephone connection. For example, an enrolled individual who has an established credit account with a store may earn time points for arriving at the store at a particular time and accumulate a certain number of additional time points, which are earned upon future events such as making a purchase within a particular window of time or making a payment on the credit account within a certain window of time.

The next step in the overview of the process is the commencement of an interaction. This commences with access being established between the individual and the other party to the interaction, whether that be a website, sales representative, or other type of presentation, as indicated by block 105. Specifically, information identifying the enrolled individual is proffered to a computer system having a database of enrolled individuals. This step is indicated by block 107, labeled PROVIDE INDIVIDUAL IDENTIFICATION INFORMATION. The step of providing individual identification information may take place in a wide variety of modes depending on the specific nature of the interaction and the available hardware and software. For example, in a physical interaction involving the enrolled individual, the interaction may commence at the individual's entry into a physical commerce location. The physical commerce location is equipped with the means for identifying the individual if the individual is an enrolled member. For example, a stand-alone kiosk may be provided inside an entrance of a physical commerce location, and furnished with equipment for obtaining information to compare to individual background profiles. For example, the kiosk may contain a computer equipped with suitable software to prompt the individual to enter an alphanumeric individual ID on a keyboard. The computer processor's under the direction of the software captures the individual ID and transmits the individual ID to a computer having a database. Suitable software on the database computer then compares the individual ID to the database to identify the individual. It will be understood that other systems may be employed in a physical commerce location, including, without limitation, swiping a magnetized strip on a card, reading a bar code, optical character recognition, and/or biometric identification. If the location is one where a service is to be provided, such as health care provider's office, an airport, or other location, the information may be entered by a representative of the service provider, in addition to other methods.

If the interaction is by telephone, caller identification technology may be employed. The individual callers may be prompted to enter codes into a telephone keypad, or to say passwords or codes that are analyzed by voice recognition systems (either software on general purpose computers or partially hardware). If the interaction is in the nature of a presentation to or in-person meeting with a representative of the participant at a location other than the participant's location, the representative may be provided with a portable device. The device may be a portable computer running suitable software, a special-purpose device, or other device. The representative or the individual may enter identification information into the device. If the interaction is from a computer running a browser to a resource over a network, suitable software at the resource may obtain identification information stored in the cookie file or other suitable location of the individual's computer.

If the individual is identified as an enrolled member by the participant system, then the information as to the time of the contact is recorded. This is indicated at decision block 110, and block 115. The time information may be recorded at a local computer or device, such as at a physical commerce location, for later updating, or immediately communicated to system computers for updating the individual background profile.

If the individual is not identified as an enrolled member, the individual may be asked for additional identification, as indicated in block 120. For example, a user who has forgotten to bring a card or has forgotten an ID number, or whose cookie files have been deleted or altered, may be prompted by a computer running suitable software to provide additional information that may be checked against the individual background profile of the particular individual. Similarly, a representative of the participant may be asked for such information. If the individual is identified as an enrolled member, then, as indicated by block 125, the process flow returns to recording of the information regarding the time of the contact and other information. If the program determines that the individual is not an existing enrolled member, the individual is offered the option of enrolling in the program, as indicated by block 130. This step only takes place at this point if the individual has not previously completed the enrollment process. This may be done in any suitable manner. For example, a form may be provided by the software and displayed for the individual to complete. The form will have directions and blocks for providing valuable background information to establish a unique individual background profile for the new program member.

In a method of the invention particularly for use in connection with retail commerce locations, the method of the invention then preferably determines if the individual is eligible for the receipt of awards, coupons, or the like which may be printed and delivered to the individual from a printer located at the kiosk. Either the local computer or a remote computer compares the information in the individual background profile against criteria established for entitlement to rewards. This is indicated by block 135.

If the individual is eligible for rewards, then the rewards will be communicated or otherwise presented to the individual. For example, coupons indicating the availability of specific discounts or other special benefits may be provided. These may be generated by printing under commands provided by suitable software running on a local computer at a kiosk. The coupons may designate discounts, points awards or the like that are available only for transactions completed on the same day, or within a certain time period after the printing of the coupon.

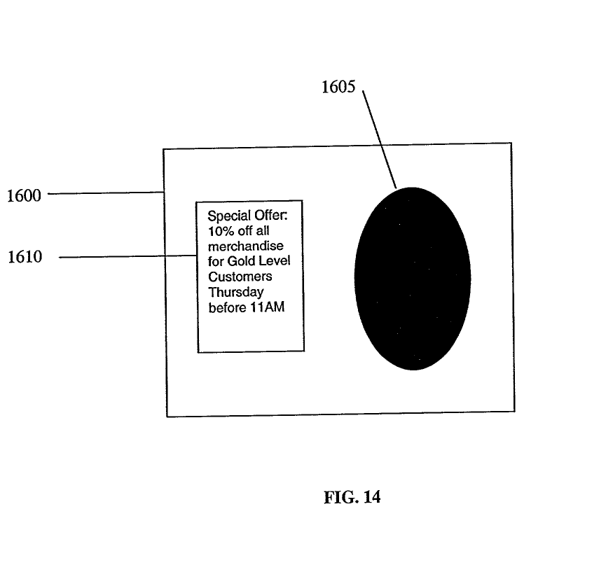

In one embodiment of the invention, particularly for use at physical commerce locations, a method and system is provided for creating categories of individuals and assigning individuals to those categories. The categories are assigned individuals in a manner preferably based on factors stored in the individual background profile. The method and system also provides for readily identifying to personnel at the physical commerce location those individuals in categories that are preferred. Personnel should be able to easily and readily identify preferred customers and other categories of individuals and to provide those individuals with a level of customer service that is appropriate under the circumstances. For example, a category of customers may be created that warrants a very high level of customer service so as to justify the consumption of the limited time and attention of the limited available personnel, or who may consume more of the limited time and attention of personnel with respect to answering questions or otherwise providing customer service. By customer service, such activities as taking more time to answer questions of the individuals, offering assistance without being requested, maintaining a longer contact with the individual, other ways of providing customer service. The step of establishing categories of customers is indicated at block 300. All individuals are assigned to one of two or more such categories, as indicated by block 305. When the individual is identified, the category to which the individual has been assigned is determined, as indicated by block 310. The computer at the kiosk is configured to print information in different fashions for different categories of customers, as indicated by block 315. The indicia indicating the category of customer is preferably readily identifiable and visible from a distance by personnel if the individual is holding the printout. The level of customer service that is provided to individuals may be based, in part upon the category of customer assigned to individuals as reflected by the indicia, as indicated by block 320. By way of example, different colors of paper may be employed for different classes of customers. By way of further example, selected areas of a piece of paper may be printed in selected colors for different classes of customers. Large, readily identifiable symbols of different types for different categories of customers may be printed on a sheet of paper, as illustrated, for example, in FIG. 14. Sheet of paper 1600 has symbol 1605 constituting indicia of a particular category of customer, and text area 1610 indicating an offer available only to customers in that category. In addition, selected areas of a sheet of paper may be printed upon or not depending on the category of customer. The indicia may be provided on a substrate other than paper. It is important that the substrate be sufficiently large and contain sufficient information that the customers will not tend to place the substrate bearing the indicia in a pocket or purse. For example, a flat substrate of at least approximately 6 inches in at least one dimension may be desirable. A sheet of paper of approximately standard letter or A4 size may also be desirable.

The means for identifying the customers could include other devices and techniques. For example, customers could be issued a disposable card, or a handheld digital communications device upon entry. A device may communicate with an in-store system of sensors that determines the location of the device and inferentially the customer who is associated with the device. Such a system could be linked with communications devices for store personnel to notify personnel of the presence of customers in a specific category. Employees may carry devices, or devices at in-store counters or similar locations may notify employees of the presence of such customers. Alternatively, the item carried by the customer could emit a sound or pattern of flashes that could be recognized. Overall, the method and system conveys to personnel the presence of individuals who fall within a certain category, and preferably identifies the category and the individual customer, as well.

It is important in this method that the information designating category of customer be visible from some distance away. For example, the information may be visible from a reasonable distance by personnel. A reasonable distance may vary according to the context. For example, in a retail store, a reasonable distance may be the length of an aisle in the store. The distance may vary from about ten feet to about one hundred feet, or even more, depending on the location. If the commerce location is a large facility, such as an amusement park, it may be desirable that the indicia identifying the category be visible from a relatively great distance, such as three hundred feet or more. The information is preferably visible from a distance at any orientation of the item held by the individual such as a sheet of paper. As a result, the customer need not hold the sheet of paper in any particular orientation. Using sheets of colored paper is particular advantageous in this regard so as to assure that the particular classification of the individual is readily visible in any orientation. Other methods, such as printing all edges of a sheet of paper on both sides in a particular color, may also be employed.

If there are no categories, as indicated by block 137 leading to block 150, rewards are simply provided to the individual. The process determines whether the individual belongs to a particular category of customers, as indicated by block 145, then the process proceeds to printing coupons or other discounts in a standard format, as indicated by block 150, or in a special format for that class of customer, as indicated by block 155.

The process flow then proceeds to an accumulation session taking place, as indicated by block 140. The accumulation session may be optional. The accumulation session may include participation by the individual in various tasks or activities, whether for a pre-determined period of time or not. Such tasks or activities may include viewing material at a website or viewing material at a particular physical commerce location. For example, the individual may attend a scheduled product demonstration at a particular physical location. If the individual indicates presence by interacting with suitable hardware to detect presence, such as another kiosk, this interaction will be recorded at a suitable location and may be considered in determining the value of the accumulation session. An incentive may be provided in the form of a higher assigned category of customer value or a higher award of time points on a per contact basis for those individuals who are willing to reconfirm their presence in the physical commerce location or elsewhere on a more frequent basis so as to reflect and confirm their presence during particular periods of time.

The method may be used in connection with accessing a wide variety of resources over a wide variety of networks. For example, the network may be a landline or cellular telephone network, and individuals may be accessing audio programming or engaging in live conversations over the network from standard or cellular telephones. By way of example, the specification describes implementations using access to internet websites from client personal computers.

If the individual has arrived at a location where points are to be accumulated only if a scheduled appointment commences later than the scheduled time, then the commencement time of the appointment must be recorded. This may be accomplished by having the individual swipe a card at the time the appointment commences, or through any of the other techniques described above. The accumulation session commences only after both the individual has been identified as having arrived, and the time for the commencing of the appointment has passed without the appointment commencing.

During the accumulation session, the attention of the individual, or proxies for the attention of the individual, may be measured. Examples of the measurement of attention are provided below in connection with accessing resources on a network. In a physical commerce location, attention may be measured as follows. A number of devices may be provided in various locations within a physical commerce location for reading or otherwise scanning information in order to identify the presence of the individual at the device. Devices may include OCR readers, bar code readers, magnetic stripe information readers, biometric identification devices, and other devices. Such devices are preferably located in a variety of locations, requiring the individual to traverse a large portion of the area of the location in order to have presence detected at each of those devices. For example, in a retail store with elongated aisles, devices may be located in such locations as the central portion of an aisle, or in the portion of an aisle at or near a maximum distance from the entrance and exit of the store. In calculating the attention measure, it will be understood that if intervals between interactions with such devices for a single individual are shorter than a threshold, the individual is merely rushing from one device to another, and would not be credited with a high level of attention. Other suitable algorithms may be developed to avoid rewarding points where the recorded information indicates an attempt to obtain a greater number of time points without actually providing the appropriate level of attention under the circumstances.

In a situation involving an in-person presentation before a single individual, a device controlled by the representative of the participant may be employed to record instances of inattention in the form of unscheduled interruptions or other distractions that tend to interfere with the attention provided by the targeted individual. The device may be programmed to provide for the entry of information such as the commencement of an interruption, the resumption of the presentation after the interruption, indications of the level of attentiveness of the individual on a suitable scale, and other information. The algorithms that are employed to calculate awards may include a reduced award for each interruption. In those cases where the interruptions are shorter than a selected threshold period of time, the interruption may be disregarded so as to have no effect upon the award of time points to the particular individual. The selection is preferably made generally for a program or participant, so that the individual representative making the presentation does not have this discretion. The measurement of the number of interruptions operates as a proxy for attention. There may be defaults provided so that the presenter will not deprive the individual of credit by forgetting to record the end of an interruption. For example, the device may periodically provide a signal requiring the presenter to respond by indicating, such as by pressing one of two buttons, whether the presentation is ongoing or in an interruption. Microphones and voice recognition software may be provided so that, by recognizing the presenter's voice and certain words, tones or cadences, the device can automatically determine when presentations commence, are interrupted, and cease.

The individual may be presented with a code or other identifying information in certain contexts, such as in connection with the purchase of items at a store location, or the viewing of a presentation at a location. The accumulation session then terminates. The termination may be accomplished by the individual affirmatively so indicating. For example, the individual in a physical commerce location may terminate the accumulation session by providing identification information to a suitable reader, which may be a computer at a separate kiosk at the physical commerce location. The representative of the participant, if applicable, may act to affirmatively terminate the session by entering the information suitably on the portable device. If applicable, the code or other information is also presented by the individual for recording by the system. The system then credits the individual for the purchases and other recorded activity that occurred during that particular accumulation session. The recorded information may include data relating to other tasks or activities in which individuals participate that participants may deem valuable, including the completion of forms and surveys, participation in real time conversations and interactions with sales representatives, participation in sales presentations, observation of product presentations that may be presented to specific individuals for purposes of obtaining a wide range of feedback and for an endless variety of other reasons including educating individuals and otherwise exposing them to products and services so as to close more sales in the long term. This step then terminates the accumulation session, as indicated by block 151, labeled ACCUMULATION SESSION TERMINATES. The computer software stores the information relative to the accumulation session that has been completed. This is indicated by block 152, labeled, SYSTEM STORES INFORMATION RELATIVE TO ACCUMULATION SESSION. The program then calculates the number of time points that were earned as a result of the accumulation session. Time points means any quantitative measure of an award calculated in part based on the duration or time of day, day of week or date of an interaction. The award of time points may be adjusted for purchases and other activities recorded during visits by an individual to a particular brick and mortar retail location at various points in time. Time points may be expressed in any suitable format, including a simple number or in units of dollars or other currency. A formula, discussed in more detail below, is employed to calculate the award of time points based on various factors. These factors include the time of day or the day of the week when the accumulation session takes place. In addition, other information may be included in the formula including consideration of the previous purchase history of the individual at various locations offline and online, together with other factors such as the navigation history of the individual on the internet, and provides additional time points as an incentive for an individual to accomplish the visit to the physical commerce location during particular times of the day and particular days of the week in general, as well as in specific instances.

In an alternative process flow, the accumulation session may commence before enrollment, as indicated by block 170. An individual may participate in an interaction and have the information derived from the resulting accumulation session recorded for later consideration. The individual is assigned identifying information. This identifying information may be a unique code, or it may be the individual's e-mail address or other personal information. The identifying information is associated with the accumulation session information and stored in a suitable database, as indicated by block 175. The individual is then enrolled, by using an enrollment process described below, with the additional step of including the unique identifier, as indicated by block 180. This permits the accumulation session to be associated with, and credited to the individual. The process flow may proceed directly to step 157, and time points associated with that session are calculated and earned by the targeted individual. It will be understood that the individual may choose to engage in additional interactions before redeeming points.

The next step involving the calculation of time points is shown by block 157, labeled CALCULATION OF NUMBER OF TIME POINTS EARNED. The calculation of the number of time points earned as a result of an accumulation session is stored in a suitable location accessible by a database. The storing of the number of time points earned creates a time points account balance for the individual. The earned time points may be redeemed for something of value, or may have intrinsic value. In one aspect of the invention, the points may be redeemed for goods, services, discounts, or money. In another aspect of the invention, the time points are required in order to obtain credit for attendance in settings where attendance is mandatory.

The next step in the process involves having an individual obtain access to an individual account balance and other information. The number of time points available to an individual is referred to as an account balance. This step is not necessary in certain types of programs or in certain time points accumulation sessions. The step is indicated by block 160, labeled INDIVIDUAL VIEWS ACCOUNT BALANCE. The next step in the process involves the redemption of some or all of the earned time points contained in the account. The redemption process may be accomplished through a number of alternative methods. There are various redemption methods for various forms of items that are well known and have many variations. For example, a central program administrator that maintains a central rewards program may regulate and/or permit redemptions and other activities. The contact with the central program administrator may be obtained via a network, such as the internet, via telephone, via mail, or via other means. The rewards program may also be administered by a group or organization associated with a particular website where the earning session may have occurred. The step of redemption is indicated by block 165, labeled INDIVIDUAL REDEEMS TIME POINTS FOR ITEM OF VALUE.

For example, a car dealership may desire to invite existing customers with leases that are nearing expiration to come to the dealership and submit to a measured accumulation session of pre-determined length or otherwise, during which time the individual will be subjected to a sales presentation, test drive and/or other forms of interaction including observing a pre-recorded presentation, if desired, in an effort to close more sales. In addition, in this scenario, the close level of scrutiny that sales representatives will provide as a natural consequence of the individual being present and in close proximity to vehicles and sales personnel will create a level of oversight and scrutiny that will satisfy the need to measure the attention of the individuals during accumulation sessions under these circumstances.

Of course, it will be understood that an individual may choose to engage in additional interactions and accumulation sessions, either before or after the step of reviewing the account. The individual may of course engage in additional interactions after the step of redeeming some or all of the points.

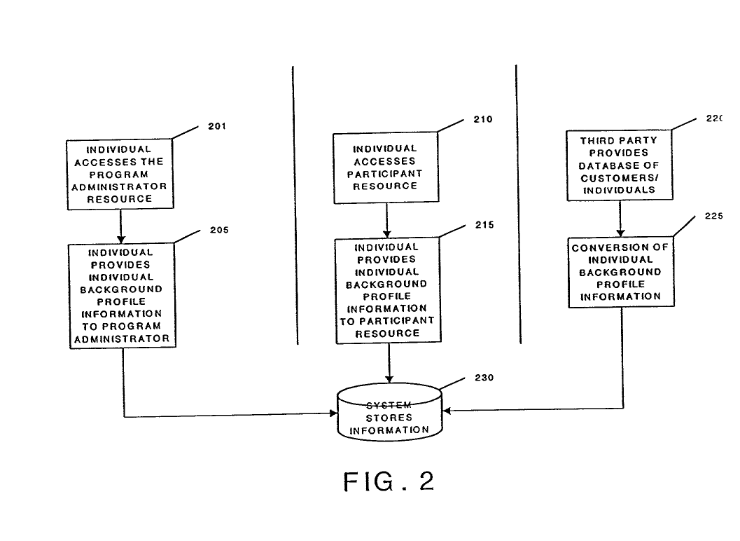

Referring now to FIG. 2, the step of enrolling an individual as a new member in a system according to the invention will be discussed in greater detail below. The enrollment of new members in the system requires the creation of new individual background profiles for those individuals. The individual background profiles contain factors consisting of specified information about an individual member of the system. The information contained in each individual background profile includes factors such as individual name, home address, office address, e-mail address, company affiliation, occupation, product or service interests, income level, previous purchase history, previous purchase abandonment history at websites on the internet, previous response to offers of time points, previous earning session results and other relevant information. These individual background profiles are obtained by having individuals provide information to the program administrator directly, such as by logging on to the program administrator's website and filling out a form. This step is shown in step 201, labeled INDIVIDUAL ACCESSES THE PROGRAM ADMINISTRATOR RESOURCE. After this step is completed, individuals provide information that is then incorporated into the individual background profiles of the individuals. This may be accomplished by way of a web-based form, as explained above. This step is indicated by block 205, labeled INDIVIDUAL PROVIDES INDIVIDUAL PROFILE INFORMATION TO PROGRAM ADMINISTRATOR. The enrollment of a new member may also occur on participant computer systems. This is shown by block 210, labeled INDIVIDUAL ACCESSES PARTICIPANT RESOURCE. These participant computer systems may be websites or they may be computer systems at physical commerce locations accessible to the individual. Alternatively, the enrollment information may be collected on a portable computer or handheld device in the custody of a representative of the participant. After this step, the individual background profile information is furnished to the participant by the individual. This step is indicated by block 215, labeled INDIVIDUAL PROVIDES INDIVIDUAL PROFILE INFORMATION TO PARTICIPANT RESOURCE. The information is then stored by the participant's computer system. If the information is obtained at a remote location, the information is later forwarded to the participant's computer system, or directly forwarded to the system of a program administrator. The participant preferably has obtained suitable information from the program administrator so that the data formats and fields are the same, though specific participant requirements may vary. The use of the same formats and fields permits the simple transfer of individual background profiles and other information to the program administrator. Another variation to the enrollment process involves having information forwarded by a third party to a program administrator. This step is indicated by block 220, labeled THIRD PARTY PROVIDES DATABASE OF CUSTOMERS/INDIVIDUALS. In most instances, the information received from the third party will not be in a format suitable for inclusion in a database. Accordingly, this branch of the process proceeds to the step wherein the program administrator converts the information provided by the third party into a suitable format. This step may involve the receipt of a database of information pertaining to specific individuals and the conversion of that information to a different format. This step is indicated by block 225, labeled CONVERSION OF INDIVIDUAL PROFILE INFORMATION. All of these branches of the process conclude with the storage of the captured information in the database, indicated by block 230, labeled SYSTEM STORES INDIVIDUAL BACKGROUND PROFILE INFORMATION. Preferably there is a single database maintained by the program administrator that contains all of the individual background profiles and other information. The storage of this information may be in a flexible database structure. The program administrator preferably matches individual background profile fields to conform to the participant data sets and populates the participant information. This may be accomplished through a variety of conversion programs. The database also maintains information regarding the participants. This includes both general information, such as participant contact information, as well as specific information such as that which is described in more detail below relating to the award of time points based upon activities that occur at participant resources.

The database containing the individual background profiles of enrolled members may include such factors as age, income level, occupation, history of previous purchases whether at particular physical commerce locations or on the internet at participant websites or otherwise, particular hobbies, interests, navigation habits, as well as a variety of other information. Additional factors include frequency of visits to retail locations, average duration of visits, and the average amount of money spent by the individual during each visit. This will ensure that offers of time points to particular individuals can be adjusted depending upon such factors as whether the individual has responded favorably to previous offers of time points. If those previous offers have been met with a desired response from the individual such as the purchase of a product that was the basis for the offer of time points, then additional offers of time points and the frequency of offers to particular individuals may be increased in the future. The tracking of this information and the incorporation of it in the individual background profiles of individuals as a factor will be measured in response to all offers that are made to particular individuals enrolled in the program and/or it may be limited to responses generated at a particular physical commerce location or at a particular participant resource, or in the context of some other selected category of interaction, such as one-on-one sales presentations. In addition, as individuals employ the methods of the invention, a substantial amount of valuable additional information will be generated from that activity and additional factors will be added as a result.

When the accumulation session is completed, the process flow proceeds to determine whether the formula requirements that were pre-selected by the resource have been met so as to result in the individual earning some or all of the time points that they had an opportunity to accumulate as a result of any applicable special offers that resulted in the visit by the individual to the particular physical commerce location at that particular time.

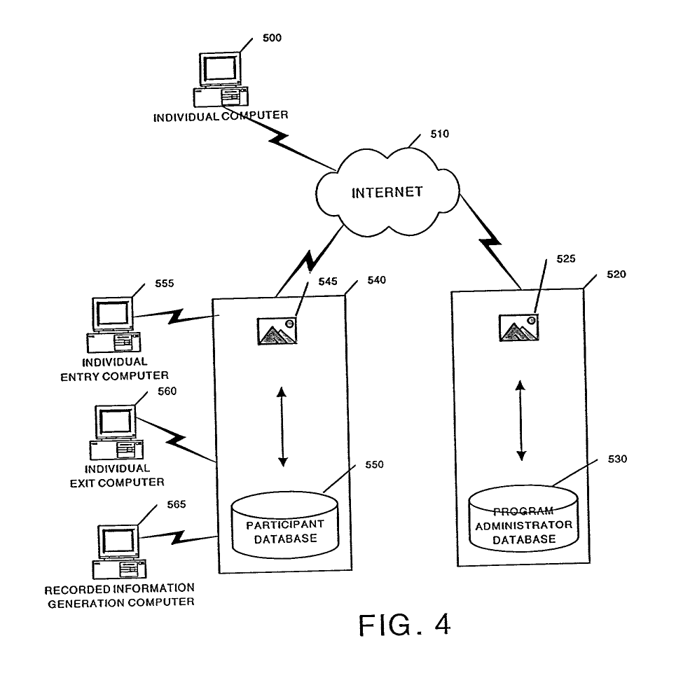

Referring to FIG. 4, elements in a system according to the invention are shown schematically. The individual computer 500 of the individual customer is shown. It is linked to the internet by suitable connections. The program administrator system 520 includes a program administrator web server 525 and program administrator database 530. The program administrator resource 525 incorporates the necessary functionality so as to enable individuals to enroll as members in a program according to the invention, to enable individuals to check and to update certain individual background profile information, such as current address information, as well as to enable individuals to monitor account balances, rewards opportunities and in order to perform a variety of other tasks and activities. In some aspects of the invention, earned points may be redeemed at the resource of the program administrator. The program administrator database contains comprehensive personal background profile information regarding each member including the up-to-date individual background profile of each member, as well as various information related to previous interactions with participants.

The program participant system 540 includes participant database 545. The participant website 545 includes a server which is running an application in accordance with the invention to track individual accumulation sessions. The participant database 550 may store a wide variety of information as desired or deemed relevant by the participant. The information relating to accumulation sessions may be transmitted by the participant system 540 to the program administrator system 520 to update the program administrator database 530. The participant's system includes participant entry computer 555. This computer is located at a kiosk adjacent the entrance to the physical commerce location. The customer provides identification information to participant entry computer 555. Participant exit computer 560 is also shown. At participant exit computer 560, the customer provides identification information in order to indicate the customer's departure from the physical commerce location and hence the termination of the accumulation session. The participant exit computer also reads recorded information. Both participant entry computer 555 and participant exit computer 560 are linked to participant computer system 540 for sharing of data. Recorded information generation computer 565 is also indicated. Recorded information generation computer 565 may include a point-of-sale terminal that provides a printout of sales transaction information, a terminal that provides confirmation of attendance by individuals at a sales presentation, or other terminals and computers providing information to be read at participant exit computer. Recorded information generation information computer need not be linked to participant system 565.

It will further be appreciated that participant computer system 540 may consist only of participant entry computer 555 and participant exit computer 560. Those computers may communicate directly with program administrator system 520. Any necessary algorithms and other required administrative information may be furnished by a participant to the program administrator, and entered into the program administrator's system by the program administrator.

The information relating to the identification of individuals may be requested by a participant system 540 from the program administrator database 530 so as to permit the proper identification of individuals who seek to commence an accumulation session in a manner as required by the participant. As noted, in an alternative, this information may be requested directly by participant entry computer 555 and participant exit computer 560.

There are other interactions and exchanges of information that may occur and that are evident from a review of this specification.

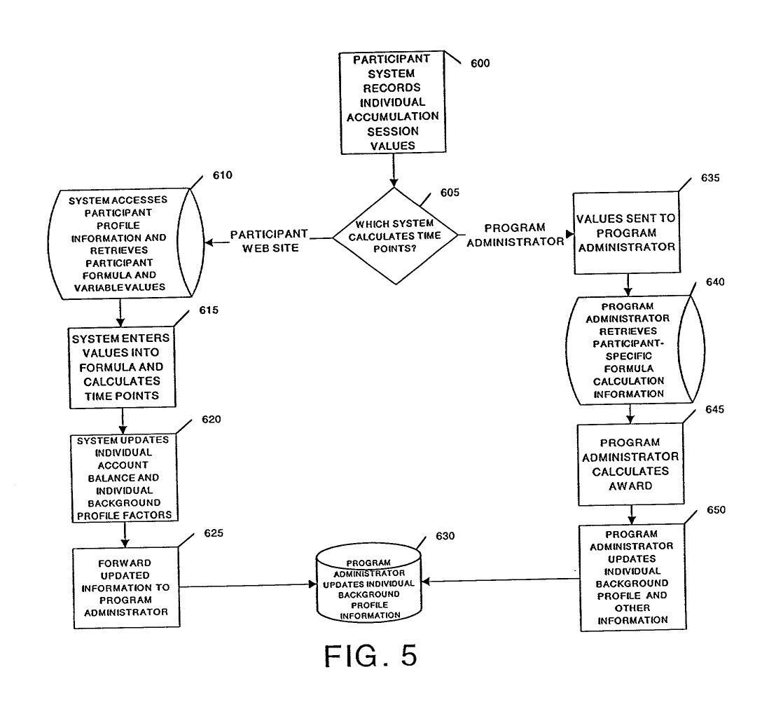

Referring to FIG. 5, there is shown a flowchart that depicts a process flow relating to the calculation of the number of time points that are actually earned as a result of an accumulation session. The calculation process commences with the recording of data from an accumulation session. At a minimum, the data that is captured includes such information as the time of day and the day of the week of the visit by the individual to the physical commerce location. The information may also include additional information such as the types of information or content viewed and the types of activities conducted during a particular visit to the brick and mortar retail locations such as the completion of forms or surveys, the observation of a product demonstration, conversations with sales representatives etc. In addition, it is anticipated that the invention may be implemented in conjunction with techniques to enable participants to offer certain presentations that may entail having individuals watch certain prerecorded content up to a certain period of time, after which a real time personal interaction or conversation with a sales representative may immediately follow. This information may be recorded and incorporated into an individual background profile as a factor to be considered by participants who are faced with the decision of which individuals represents the best prospects to target with offers of time points earning opportunities in particular physical commerce locations. This step in the process is indicated by block 600, labeled PARTICIPANT SYSTEM RECORDS INDIVIDUAL ACCUMULATION SESSION VALUES. The process flow may then proceed in two different flows, depending upon whether the participant system or the program administrator system calculates the actual number of time points that the individual has earned as a result of an accumulation session. This decision is indicated by block 605, labeled WHICH SYSTEM CALCULATES TIME POINTS? If the participant engages in the calculation process, the process flow proceeds to access the data maintained by the participant that relates to the formulas and viable information that is relevant to the calculation process being completed. This step in the process is indicated by block 610 and is labeled SYSTEM ACCESSES PARTICPANT PROFILE INFORMATION AND RETRIEVES PARTICIPANT FORMULA AND VARIABLE VALUES. The participant system accesses the individual background profile information that it may maintain regarding a particular individual. In addition, the participant may create its own formulas to determine the rate at which to award time points to individuals during particular visits to a particular physical commerce location. The participant may also establish accumulation session rules and guidelines that may result in certain selected portions of the time of the visit to be disregarded in determining the specific period of time that constitutes an accumulation session. For example, the participant may establish rules that specify that the initial period of the visit is not credited to the individual and is not considered part of the measured period of the visit for purposes of calculating the earning results of an accumulation session. If the duration of the accumulation session is excessive, the duration may be reduced or otherwise discounted on the assumption, for example, that the individual exited the physical commerce location and later returned. In addition, time points may not be earned if it is determined that the length of the accumulation session failed to meet resource-imposed minimum time requirements. It may also be determined by participants that the imposition of a time of day or day of week requirement so as to dictate when visits by individuals to particular physical commerce locations and related time points accumulation sessions will occur is appropriate. This feature enables participants to offer time points in such a way as to steer individuals to make physical visits to particular physical commerce locations at particular times. For example, the algorithm may be directed to encourage individuals to physically visit physical commerce locations in order to engage in transactions and/or interactions during a time of the day with an established record of low traffic volume, to entice particular individuals to visit particular brick and mortar locations in order to engage in a personal interaction with a representative of the participant for a specific or lengthened period of time and for many other desirable reasons. Moreover, participants may offer particular individuals a faster rate of accumulation of time points in return for reviewing specific content, both live and prerecorded, such as a sales presentation or product demonstration, or for performing any other desirable tasks or activities.

A random time points reward incentive feature may be offered, as well. In this aspect of the system, certain individuals may be selected for receipt of a random reward of time points because they possess certain desirable demographic or other qualities, or they may be chosen based upon the measured length of time of their visit to a particular physical commerce location or based upon the time of day of the visit or other criteria determined to be relevant by the participant. In addition, individuals may be notified that they are one of a number of individuals who are eligible to be selected to randomly receive bonus time points during a selected period of time that may coincide with their visit or to have their time of stay factor increased so as to result in a higher rate of accumulation during future accumulation sessions or while conducting other activities. In regard to demographic information, such information as individual income levels, previous purchase history and/or rating, age bracket, type of employment, and a variety of other information may be stored. These factors and others may be employed in calculating a factor that may be included within a formula, or they may be used directly in a formula used to calculate the number of time points earned by an individual as a result of a particular accumulation session.

In the next step, the system enters the information into the formula and calculates the number of time points earned by an individual, as shown by block 615, labeled SYSTEM ENTERS VALUES INTO FORMULA AND CALCULATES TIME POINTS. The process flow then proceeds to update the account balance of the particular individual. The individual background profile factors of individuals may include information obtained during accumulation sessions. This step is illustrated by block 620, labeled SYSTEM UPDATES INDIVIDUAL ACCOUNT BALANCE AND INDIVIDUAL BACKGROUND PROFILE FACTORS. The participant system then transmits this information to the program administrator. This may be sent via internet communications using a data transfer mechanism such as HTTP Post or other suitable means of sending information on the internet. This step is indicated by block 625, labeled FORWARD UPDATED INFORMATION TO PROGRAM ADMINISTRATOR. The process concludes with the storage of the updated individual background profiles in the program administrator's system. This step is indicated by block 630, labeled PROGRAM ADMINISTRATOR UPDATES INDIVIDUAL BACKGROUND PROFILE INFORMATION. If the program administrator calculates the number of time points that are earned as a result of an accumulation session, then as indicated by block 635, labeled VALUES SENT TO PROGRAM ADMINISTRATOR, the information obtained during the accumulation session is forwarded to the program administrator. The program administrator then reviews individual background profile information relating to preferences set by the participant. The program administrator maintains this information in its database and can retrieve it and various participant-specific formulas for calculating time points in specific circumstances. This is indicated by block 640, labeled PROGRAM ADMINISTRATOR RETRIEVES PARTICIPANT-SPECIFIC CALCULATION INFORMATION. The process then proceeds to the step in which values are entered into the formula and the earning calculation occurs. This step is indicated by block 645, labeled PROGRAM ADMINISTRATOR CALCULATES AWARD. The program administrator then updates the records it maintains relating to the individual background profile information. This step is indicated by block 650, labeled PROGRAM ADMINISTRATOR UPDATES INDIVIDUAL BACKGROUND PROFILE AND OTHER INFORMATION.

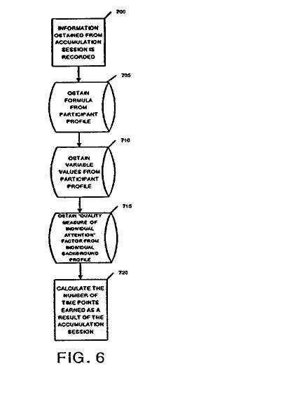

Referring to FIG. 6, there is shown a process flow relating to calculating the award of time points for a single accumulation session. The process flow begins with recording the information, shown by block 700, labeled INFORMATION OBTAINED FROM ACCUMULATION SESSION IS RECORDED. This information includes the identification of the individual, the length of the accumulation session, the length of time that the individual has otherwise spent at the physical commerce location and other factors as discussed above. The process then obtains a formula from a participant individual background profile, as indicated by block 705, labeled OBTAIN FORMULA FROM PARTICIPANT PROFILE. The system then obtains variable values from the participant individual background profile. The participant sets the variable values. This step is indicated by block 710, labeled OBTAIN VARIABLE VALUES FROM PARTICIPANT PROFILE. Variable values may include such information as the overall time points, per period of time, a number of time points based upon recorded locations that are deemed to be placed in a desirable location such as relatively far from the entrance and exit, a number of time points per survey or other task completed, and a standardization factor to conform to the rewards programs at other websites. The duration of contact information may also include a number of minutes for a first type of contact, and a number of minutes for a second type of contact, with differing points per minute for different types of contact. For example, an individual may spend a certain amount of time reviewing general information in a physical commerce location and then spend another period of time viewing a real-time video touting particular products or services. The next step is the calculation of the number of time points earned by the individual as a result of a time points accumulation session. This step is indicated by block 720, labeled CALCULATE THE NUMBER OF TIME POINTS EARNED AS A RESULT OF THE ACCUMULATION SESSION. The calculation of the number of time points earned by an individual as a result of an accumulation session is determined by inputting the data obtained from the time points accumulation session recorded on the receipt obtained by the individual at the check-out counter and entered at the kiosk or other platform, together with the variable values from the participant individual background profile into the formula selected by the participant.

The program administrator may establish a listing of various merchandise and the number of time points that are required to reach those levels that will enable an individual to redeem earned time points for the selected merchandise, services or other items of value, preferably at a location on the program administrator's resource. These activities are added factors to be incorporated into individual background profiles of members. When the program administrator updates the individual background profile of an individual with new earning activity results, the updated account balance information is compared to the number of time points that are required for an individual to reach certain preferred rewards levels. A message may then be generated by the resource and/or the program administrator to notify the individual that a specific additional number of time points are required in order for the individual to become entitled to receive a preferred reward that is of interest to them. This information may be provided by e-mails, pop-ups for individuals connected to a participant's resource or website, communications to wireless phones, personal digital assistants and/or other types of communications devices and may be accompanied by an invitation for the individual to engage in a specific activity that may enable the individual to reach the desired time point earning threshold.

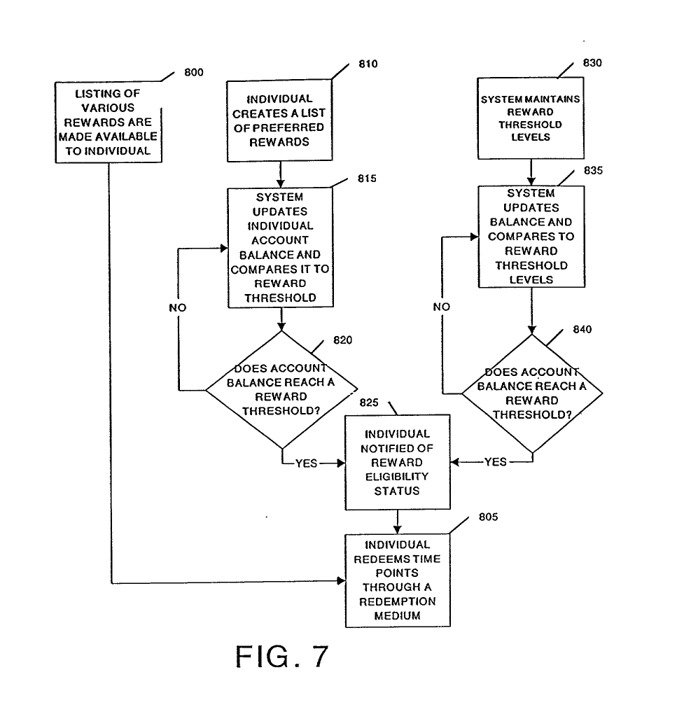

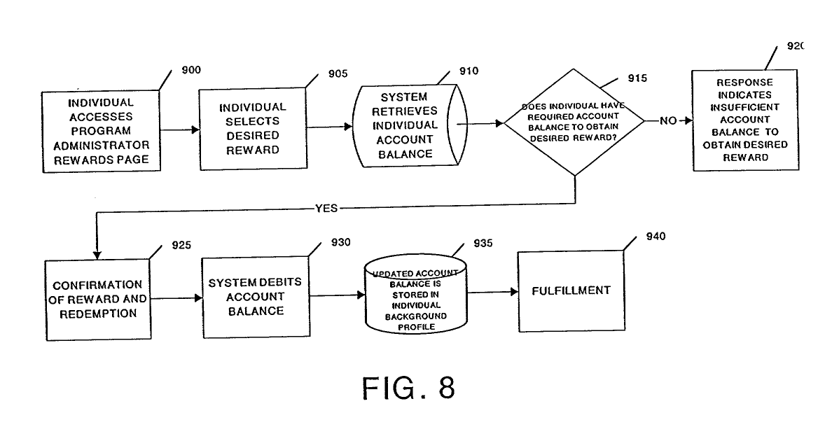

A variety of redemption processes are provided. Referring now to FIG. 7, there are shown three separate commencements to the process flow for redemption. These may proceed through four different methods of redemption. The process flow begins in one branch by making rewards available to individuals. This may be accomplished through any appropriate means, including by way of on-line or hard copy catalogs. This step is indicated by block 800, labeled VARIOUS REWARDS ARE MADE AVAILABLE TO INDIVIDUAL. The process flow continues with the redemption through a redemption medium. The nature of the redemption medium will be discussed in greater detail below. This general step is indicated by block 805, labeled INDIVIDUAL REDEEMS TIME POINTS THROUGH A REDEMPTION MEDIUM. The process then moves to one of three possible specific redemption models, which are discussed below with reference to FIGS. 8-10.

The redemption process may commence with the creation of a preferred rewards list of rewards that have been selected by the individual as items that they would prefer to receive above others. If this feature is employed, individuals will be presented with the opportunity to indicate, by communication with the program administrator or a participant, those preferred rewards that they hope to obtain through the time points program. For example, a program according to the invention may provide a web-based catalog of items, some of which may be included in a preferred rewards list. After logging on and after being adequately identified by the program administrator or by the resource of a participant, an individual may be able to view the selected items on the preferred rewards list so as to create an ongoing form of enticement to individuals and as a constant reminder of the need to seek out additional time points earnings opportunities, as well as a form of advertisement to which individuals may be willing to be exposed. The individuals may gain access to particular items for selection purposes through buttons on web pages and through the use of other existing technologies. The items may be presented to individuals in any other manner, such as by e-mail messages, by postal mail, telephone or other forms of communication. This step is indicated by block 810, labeled INDIVIDUAL CREATES A LIST OF PREFERRED REWARDS. The preferred rewards list, including the identification of specific items and an indication as to the number of time points required to obtain them, are stored in the individual background profile of the individual maintained by the program administrator's database. The process flow then proceeds to the system comparing the account balance of the individual to the items contained on the preferred rewards list. For example, after each accumulation session, upon calculation of the updated time points total in the account of the individual, the program administrator may also determine by way of calculation whether a preferred reward threshold to obtain an item on the preferred rewards list has been reached. The assessment as to whether preferred rewards thresholds have been met or exceeded may take place while accumulation sessions are in progress. As noted below, the individual may be advised that a specific preferred rewards threshold is near to being reached and that the individual must earn a specific number of additional time points in order to reach that preferred rewards threshold. The step of comparing the calculated time points account balance total to the required threshold levels established in the preferred rewards list of the individual is indicated by block 815, labeled SYSTEM UPDATES INDIVIDUAL ACCOUNT BALANCE AND COMPARES IT TO REWARD THRESHOLD. This is followed by decision block 820, labeled DOES ACCOUNT BALANCE A REWARD THRESHOLD? If not, then the process returns to the step of updating the account balance total and comparisons. If the account balance exceeds a threshold level necessary to title the individual to one of the items on the preferred rewards list, then the process moves to the step of notification of the individual. This step is indicated by block 825, labeled INDIVIDUAL NOTIFIED OF REWARD ELIGIBILITY STATUS. The process then moves to the step of redeeming earned time points for a selected item through a redemption medium.

The redemption process may also commence with the establishment of preferred reward thresholds, either by the program administrator or by one or more participants. The preferred rewards threshold levels are the numbers of time points necessary to entitle an individual to a particular reward or group of rewards. The preferred reward threshold levels may be established in a variety of ways. For instance, preferred rewards may be specific time points levels, such as 10,000 time points, 15,000 time points, and so on, each of which corresponds to a specific category of reward offering that is available to the individual. As an alternative to making rewards available to individuals in a range of time points levels, the software of the invention may be employed to set specific reward levels, as well. These threshold levels create tangible reward thresholds that individuals can strive to reach in order to become entitled to select a specific reward offered at a particular rewards level. As with the preferred rewards list feature discussed above, the program administrator may compare updated account balance totals to established threshold levels, and notify individuals when account balances approach or reach those levels. This aspect of the process flow is shown by block 830, labeled SYSTEM MAINTAINS REWARD THRESHOLD LEVELS. The reward threshold levels may be maintained by the program administrator. The system, as previously noted, compares the current account balance of the individual to applicable rewards threshold levels. This step is shown by block 835, labeled SYSTEM UPDATES ACCOUNT BALANCE AND COMPARES IT TO REWARD THRESHOLD LEVELS. The system then determines whether the account balance of the individual is equal to, or exceeds an established reward threshold level. This step in the process is show in block 840 labeled SYSTEM UPDATES ACCOUNT BALANCE AND COMPARES IT TO REWARD THRESHOLD LEVELS. If the account balance is below the applicable rewards threshold levels, the account is updated to reflect that fact. If the account balance has reached an applicable rewards threshold, the individual is notified that they are entitled to receive a reward based upon their present account balance 825 labeled INDIVIDUAL NOTIFIED OF REWARD ELIGIBILITY STATUS. At that point, if so desired by the individual, the next step in the process flow is shown in block 805 and labeled INDIVIDUAL ACCOMPLISHES REDEMPTION THROUGH A REDEMPTION MEDIUM.

Various redemption methods will now be described, referring to FIGS. 8-10. A method for redemption using the program administrator's resource, such as a website, will be described with reference to FIG. 8. The redemption process commences with the individual accessing the program administrator's resource. Specifically a portion of the resource is accessed that is dedicated to time points redemption. It will be appreciated that the identity of the individual may be required to be confirmed before a redemption may take place. It may be the case that this will occur on a page on the website of the program administrator. This step is indicated by block 900, which is labeled INDIVIDUAL ACCESSES PROGRAM ADMINISTRATOR REWARDS PAGE. The rewards page presents the individual with a selection of goods and services that may be redeemed. The rewards page may be a uniform rewards page listing all of the goods and services available to be redeemed. Alternatively, the particular items displayed in the rewards page may be selected based upon particular demographic information in the individual background profile of the individual. The order and prominence of rewards items may also be adjusted depending upon the information contained in the individual background profile of the individual. The program administrator may create a variety of algorithms based upon information contained in the individual background profiles, and create corresponding versions of the rewards page for various ranges of results of algorithms.

After the reward page is presented to the individual, the individual selects a desired reward from the rewards page. This may be accomplished by any suitable method, such as by pressing a virtual button adjacent to a display on the page pertaining to the reward. This step is indicated by block 905, labeled INDIVIDUAL SELECTS DESIRED REWARD. The process flow then proceeds to the step of having the system retrieve, the account balance, from the stored individual background profile of the individual. This step is indicated by block 910, labeled SYSTEM RETRIEVES INDIVIDUAL ACCOUNT BALANCE. The process then proceeds to the step of comparing the account balance of the individual with the number of time points required to obtain the desired reward. This is indicated by decision block 915, labeled DOES INDIVIDUAL HAVE REQUIRED ACCOUNT BALANCE SUFFICIENT FOR DESIRED REWARD? If the result of the comparison is that the account balance of the individual is not sufficient to enable the individual to obtain the desired reward, then an HTML response is provided to the individual indicating that the current account balance is insufficient to entitle the individual to a reward. The specific number of additional time points that the individual must earn in order to reach the desired reward level is preferably displayed as part of the response. This step is indicated by block 920, labeled RESPONSE INDICATES INSUFFICIENT ACCOUNT BALANCE TO OBTAIN DESIRED REWARD. It will be understood that the system may be programmed to review the account balance of the individual before displaying the rewards page, and that the system may then display only those rewards that require a certain number of time points below the account balance of the individual at that time. Other variations are possible, such as including rewards in the display that are within a selected range over the present account balance so that the individual has an incentive to strive to earn the additional number of time points that are necessary to enable the individual to obtain the reward.

If the comparison of the account balance of the individual to the number of time points required in order to entitle the individual to receive the selected reward, indicates that the individual has a sufficient account balance to receive the selected reward, the individual is notified of the selection of the reward and the number of time points that were redeemed as a result, as well. This is accomplished preferably both by an immediate HTML screen, and by e-mail to the e-mail address of the individual contained in the individual background profile of the individual. This step is shown by block 925, labeled CONFIRMATION OF REWARD AND REDEMPTION. The system then debits the account balance of the individual. This step is indicated by block 930, labeled SYSTEM DEBITS ACCOUNT BALANCE. The process flow then proceeds to the step of storing the newly calculated account balance contained in the individual background profile of the individual. This step is indicated by block 935, labeled UPDATED ACCOUNT BALANCE IS STORED IN INDIVIDUAL BACKGROUND PROFILE. The next step is generally fulfillment. This step includes transmission of a message from the program administrator's system to an appropriate fulfillment company, or to a fulfillment operation that is internal to the program administrator in order to effect the fulfillment process. The process of fulfillment may take any suitable form, and may involve sending a physical reward via postal mail or delivery service to the individual or by sending a physical certificate to them that can be exchanged for goods and/or services at a bricks and mortar company location, a catalog or through on-line retailer or other service provider, by providing information in order to obtain a virtual certificate for goods or services that may be redeemed at a retailer or other service provider, by conversion into other types of points contained in other rewards programs operated by other organizations (e.g., a frequent flyer mile type program), or other form of fulfillment process. This is shown by block 940, labeled FULLFILLMENT.

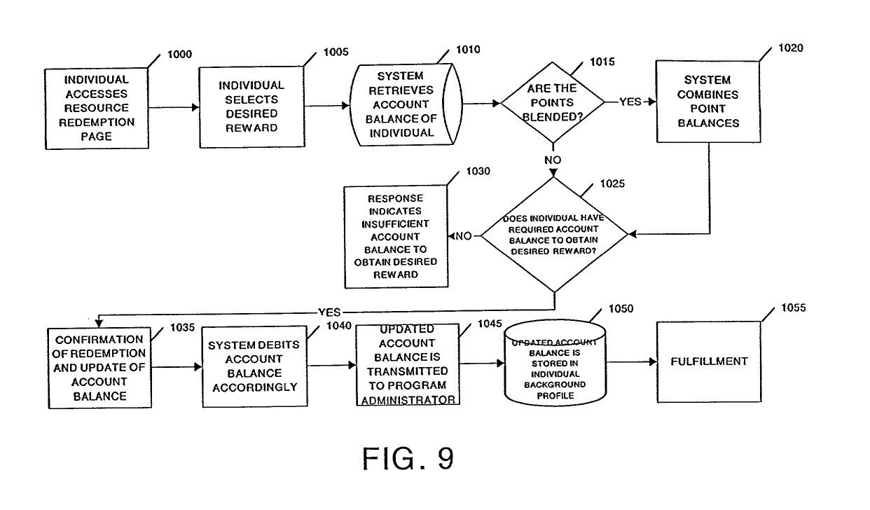

Referring now to FIG. 9, the steps contained in the reward redemption process that occurs through a participant will be described. The participant may maintain a closed system. In a closed system, the time points that are earned at the participant's website (or other resource) may only be redeemed at the participant's website. Moreover, time points earned elsewhere may not be redeemed at the participant's website. The participant may also elect to make redemption of time points earned elsewhere possible, or the redemption of time points earned elsewhere may be included up to a certain limit, fraction or percentage of the total number of time points that are required to accomplish the redemption in which they are combined. The process commences with the enrolled member of the program accessing the website of the participant. Specifically a portion of the resource of the participant that is dedicated to time points redemption is accessed. It will be appreciated that the identity of the individual is confirmed before a redemption transaction may occur. The resource may specifically be a page on the website of the participant. This step is indicated by block 1000, which is labeled INDIVIDUAL ACCESSES RESOURCE REDEMPTION PAGE. The rewards page, as with the rewards page of the program administrator, presents the user with a selection of goods and services that may be redeemed. Other options regarding to the presentation of rewards pages are available to the participant. Thus, the rewards page may be a uniform rewards page listing all of the goods and services available to be redeemed. Alternatively, the particular items displayed in the rewards page may be selected based on specific demographic information contained in the individual background profile of the individual. The order and prominence of rewards items that are offered may also be adjusted depending upon the information contained in the individual background profile of the individual. The participant may, by itself or with the assistance of the program administrator, create algorithms based upon information contained in individual background profiles of individuals and create corresponding versions of the rewards page for various ranges of results of the review of the algorithms.

After the participant's reward page is presented to the individual, the individual selects a desired reward from the participant's rewards page. As with a selection that takes place on the program administrator's rewards page, this step of the selection process may be accomplished by any suitable method, such as by pressing a virtual button adjacent to a display on the page pertaining to the reward. This step is indicated by block 1005, labeled INDIVIDUAL SELECTS DESIRED REWARD. The process flow then proceeds to have the participant system retrieve the account balance from the individual background profile of the individual. This requires the transmission of a request to the program administrator's system, a check of the program administrator's database for this information contained in the stored individual background profile, and transmission of the updated results by the program administrator's system to the participant's system. If the participant maintains the current account balance, the participant may simply check its records. This step is indicated by block 1010, labeled SYSTEM RETRIEVES ACCOUNT BALANCE OF INDIVIDUAL. The next step in the process flow depends on whether the time points are blended with other points in the participant's program. For example, the participant may permit the individual to combine time points with frequent flier miles, frequent purchaser points, or other promotional program points. This branching is indicated by decision block 1015, labeled ARE THE POINTS BLENDED? If the time points are blended with other points, the process flow proceeds to the step of combining the time points with other points. This step is likely carried out by the participant's computer system employing software specific to the participant. The value to be assigned to the combination of time points and other points contained in an account may be according to any weighting formula selected by the participant. The participant system has information related to the total number of other types of points previously earned elsewhere by the individual. That information is accessed, and a total combined account balance is calculated and stored.

The process then proceeds from the step of determining the time points account balance or the step of calculation of the blended points balance, to the step of comparing the number of time points required to reach the next available desired reward to the applicable account balance of the individual. This is indicated by decision block 1025, labeled DOES INDIVIDUAL HAVE SUFFICIENT ACCOUNT BALANCE FOR DESIRED REWARD? If the result of the comparison is that the account balance of the individual is insufficient to enable the individual to obtain the desired reward, then an HTML response is provided to the individual that indicates that there is an insufficient account balance in order to entitle the individual to receive a reward. The difference between the required number of time points to receive a reward and the current account balance is preferably displayed as part of the response. This step is indicated by block 1030, labeled RESPONSE INDICATES INSUFFICIENT ACCOUNT BALANCE TO OBTAIN DESIRED REWARD. It will be understood that the system may be programmed to review the time points account balance or the blended points account balance of the individual before displaying the rewards page, and then displaying only those rewards that require a certain number of time points below the current balance of the individual. Other variations are possible, such as including rewards in the display that are within a pre-determined number of time points of the current account balance as an incentive to engage in additional earning opportunities, if available, in order to earn more points.

If the comparison of the account balance of the individual and the number of time points required for the reward indicates that the individual has a sufficient account balance in order to entitle the individual to a reward, then the individual is notified of the selection of the reward and the number of time points that were redeemed as a result of transaction. This is accomplished preferably both by an immediate HTML screen, and by e-mail to the e-mail address of the individual reflected in the individual background profile of the individual. This step is shown by block 1035, labeled CONFIRMATION OF REDEMPTION AND UPDATE OF ACCOUNT BALANCE. The system of the participant then debits the account balance of the individual. This step is indicated by block 1040, labeled SYSTEM DEBITS ACCOUNT BALANCE ACCORDINGLY. The process flow then proceeds to transmit the newly calculated balance to the program administrator. This step is shown by block 1045, labeled UPDATED ACCOUNT BALANCE IS TRANSMITTED TO PROGRAM ADMINISTRATOR. Alternatively, rather than calculate the updated account balance, the participant system may transmit the number of time points that were debited from the account to the program administrator, and permit the program administrator to calculate the updated account balance. The system of the program administrator stores the updated account balance in the individual background profile maintained by the program administrator. This is indicated by block 1050, labeled UPDATED ACCOUNT BALANCE IS STORED IN INDIVIDUAL BACKGROUND PROFILE. The next step is generally fulfillment. This step includes the transmission of a message from the participant's system to an appropriate fulfillment company, or to a fulfillment operation that is internal to the participant in order to effect the fulfillment process. As noted above, fulfillment may take various forms. This is shown by block 1055, labeled FULFILLMENT.

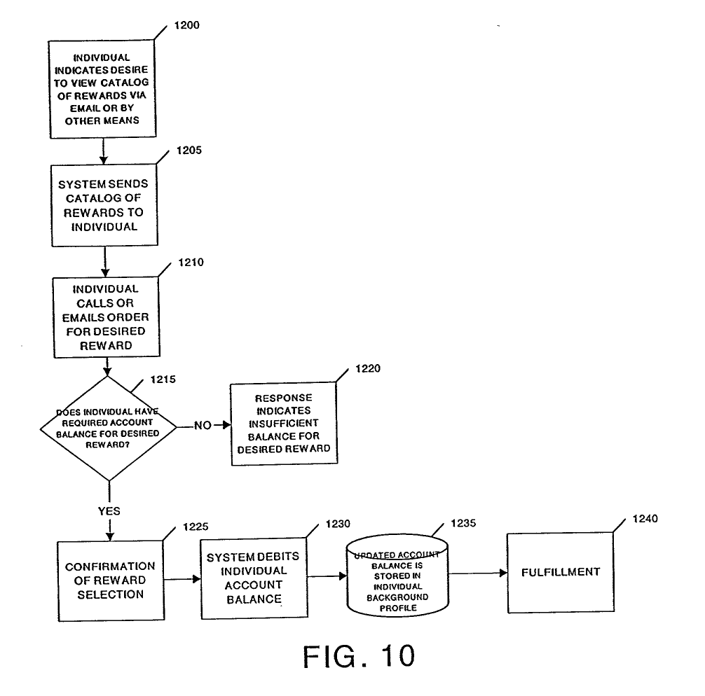

Referring now to FIG. 10, there will now be explained a redemption method that employs the use of offline catalogs. This method may be used as an alternative to having redemptions occur at a website or other resource accessed over the Internet. The process flow commences with the individual indicating a desire to view a particular catalog of rewards. The individual may do this by contacting the administrator or participant, as the case may be, in any suitable manner. This step is illustrated by block 1200, labeled INDIVIDUAL INDICATES DESIRE TO REVIEW CATALOG OF REWARDS VIA E-MAIL OR BY OTHER MEANS. Alternatively, a catalog may be provided without affirmative action by the individual; this may be accomplished by mail when a particular account threshold is reached, or periodically in order to motivate greater interaction with the system. The catalog is sent to the individual, by hard copy in postal mail, by e-mail in PDF or other convenient format, or by delivery of CD-ROM or other storage medium. The off-line catalog may also be made available for review at the retail store or other physical commerce location. This is shown by block 1205, labeled CATALOG OF REWARDS TO INDIVIDUAL PRESENTED TO INDIVIDUAL. After the individual selects a desired reward from the catalog, the individual contacts the appropriate entity, program administrator or participant and places an order for the reward. If the individual is at the physical commerce location, the individual may accomplish this by interacting with personnel, or interacting with a suitably programmed computer with access to the time points database. This step is shown by block 1210, labeled INDIVIDUAL PLACES ORDER FOR DESIRED REWARD. It will be understood that the order may be entered by other means such as postal mail, as well. The appropriate system, program administrator or participant, has the order input, and then compares the time points required to obtain the reward to the number of time points contained in the account of the individual. This step is indicated by decision block 1215, labeled DOES INDIVIDUAL HAVE REQUIRED ACCOUNT BALANCE FOR DESIRED REWARD? If not, then a response is generated to the individual to the effect that the account balance of the individual is insufficient to obtain a desired reward. The response may also indicate the number of additional time points that are required to obtain the desired reward. This step is indicated by block 1220, labeled RESPONSE INDICATES INSUFFICIENT ACCOUNT BALANCE TO OBTAIN DESIRED REWARD. The response may be provided in any appropriate form, such as e-mail, telephone, or postal mail, or by verbal notification at a retail store location.

If the account balance is sufficient to obtain the desired reward, then the reward selection is confirmed by a communication to the individual. This is indicated, as shown in block 1225, labeled CONFIRMATION OF REWARD SELECTION. The communication may be by e-mail, telephone, or postal mail, or by verbal notification at a retail store location. The program administrator's system then debits the account balance of the individual appropriately. This is shown by block 1230, labeled SYSTEM DEBITS INDIVIDUAL ACCOUNT BALANCE. The individual background profile of the individual maintained in the database of the program administrator is updated with the new account balance. This is shown by block 1235, labeled UPDATED ACCOUNT BALANCE IS STORED IN INDIVIDUAL BACKGROUND PROFILE. Fulfillment services are provided to send the reward to the individual, in one of a number of manners as described above. This step is indicated by block 1240, labeled FULFILLMENT.

The redemption process may also be carried out at a third party redemption center, which is neither the program administrator, nor a participant. Such a redemption center may provide either on-line or off-line redemption services. Such centers may redeem time points for items other than merchandise, including cash, other reward points in other promotional programs, such as frequent flier miles or points for other users of other services, and the like.

The method of the invention constitutes a new and flexible form of perk that may be used by business to consumer sales oriented companies that sell products and/or services from particular physical commerce locations in a wide variety of industries. In fact, the invention is applicable and valuable in any seller oriented context wherein it is necessary for a seller to cultivate a sales prospect and where it would be helpful to be able to entice particular individuals with the offer of time points for their time at particular physical commerce locations in order to close a sale, or where it is desirable to reward an existing important client who is willing to take the time to interact with the company for whatever reason. For example, the method of the invention can be employed to reward a sales prospect for providing their important and valuable time and attention to listen to a sales presentation in a face-to-face interaction or meeting.

The invention will enable businesses to offer time points to any particular selected sales prospect or to any existing important clients or customers while they engage in a conversation with them or otherwise provide their time and attention at physical commerce locations and other venues for any reason. This will enable sales representatives to engage sales prospects and to interact with them in order to demonstrate new products while the individuals listen to sales presentations, product descriptions, etc. The availability of the time points may be limited to prospects with a demonstrably high likelihood that they will respond to presentations wherein time points are offered in order to capture the valuable time and attention of particular individuals with a purchase or other positive reaction.

The method of the invention may be employed by banking and other financial institutions to induce enrolled individuals in order to entice them to visit particular physical commerce locations at particular times so as to learn about available products and services and to read important information such as articles relating to certain products and services including those products and services that may then be the subject of a conversation with a sales representative at a later point in time during the visit to the physical commerce location. It is well recognized that individuals are willing to rely upon the internet to educate themselves regarding particular product s and services, but when it comes to actually making a purchase, individuals are resistant to completing the purchase over the internet. In one example, the offers of time points may be made to individuals contingent upon those individuals agreeing to submit to a series of interactions of a pre-determined duration and possibly at particular times of the day, in which presentations are made and in which the final accumulation session in the series involves personal interaction with a live sales representative. Thus, the live interaction with a sales representative will occur after individuals have been educated, to some extent, regarding the relevant products and services that were the subject of the presentations and at a point when they may be more receptive to a personal sales presentation in order to convince them to complete the purchase of a product that had been the subject of the series of presentations. In addition, individuals can be shepherded through the purchase process that occur at physical commerce locations. This will have the additional benefit of enabling sales representatives to personally assist individuals to complete the sales process so that those same individuals will enjoy the benefits of the special attention they receive, thus, inspiring greater overall customer loyalty and satisfaction. The method of the invention may also be used by any industry in order to educate specific enrolled individuals regarding products and services that are geared to those particular individuals. The method may be employed generally to entice pre-screened individuals, who may or may not be existing customers, to rely upon the resource as a source for information instead of relying upon a live service representative to answer every customer inquiry.

The method of the invention may also be employed in the offline gaming industry. The award of time points may be offered to individuals in such a way as to extend the abilities of particular brick and mortar gaming establishments to influence the timing and flow of traffic to them and to enable them to offer an effective redemption procedure that may possibly be used in combination with other points programs.

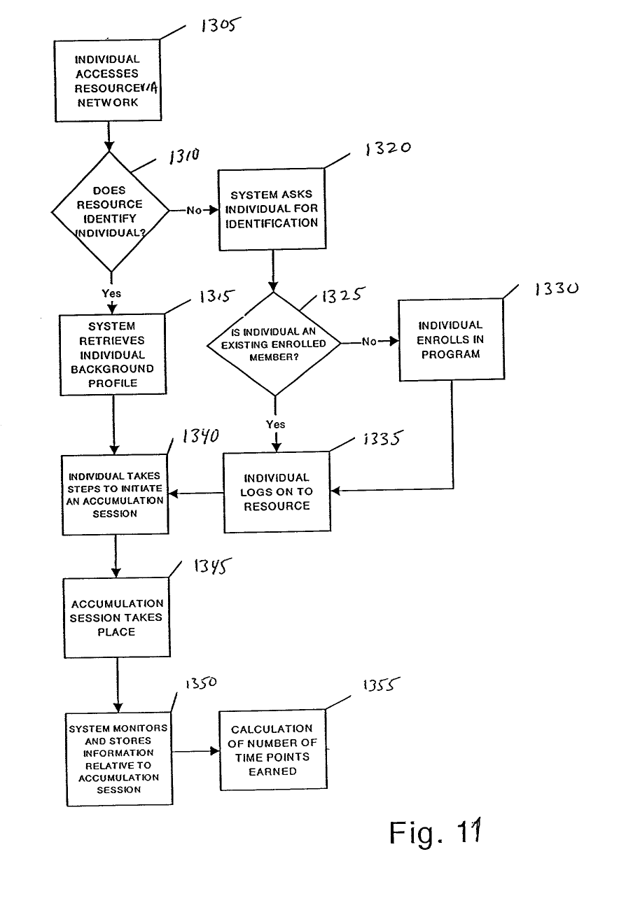

The method of the invention may also be combined with a rewards program which involves the award of time points based on connection time from an individual's browser to a resource on a network, such as from a computer with a web browser to a website accessible over the Internet. Such a system will now be described with reference to FIG. 11. Referring now to FIG. 11, there is shown a high-level process flow of this method. By way of example, the description below sets forth implementations using access to Internet websites from client personal computers.

An individual who has enrolled in the program accesses the resource maintained by the program administrator. If the individual has not previously participated in the program using a computer, the individual may need to update the individual background profile. This may be done automatically, such as by having the program administrator website store information in the individual's browser's cookie file. Following this step, the individual accesses a network resource that is configured to employ the method of the invention. For example, the network resource may be a server maintaining pages accessible via the internet. The individual accesses the network resource from a suitable device that is configured to access network resources of this type. This device may be a personal computer running a browser, such as Internet Explorer or Netscape Navigator. The device may also be an Internet appliance, of which there are various types. This step is shown by block 1305, labeled INDIVIDUAL ACCESSES RESOURCE VIA NETWORK.

The server on which the resource is located has a computer program in operation according to the invention. The computer program, upon accessing of the resource by a particular individual, determines whether the individual is properly identified. This step in the process is indicated by decision block 1310, labeled DOES RESOURCE IDENTIFY INDIVIDUAL? This step includes receiving identification information from the individual's device, or the client, and correlating that received information with stored identification information concerning enrolled individuals. The step of identification may be carried out by various known means. For example, the website may check the cookie file of a browser on the individual's client, and check the cookies against a file in a database of known individuals. If the server recognizes the individual, then the previously stored Individual background profile is retrieved from a suitable database. This is indicated by block 1315, labeled SYSTEM RETRIEVES INDIVIDUAL BACKGROUND PROFILE. If the resource does not recognize the individual, then the process moves to the step of the resource asking the individual to provide identification. This may be achieved in any suitable manner. For example, a web-based form may be provided via the network to the client's browser and displayed for the individual. This step is indicated by block 1320, labeled SYSTEM ASKS INDIVIDUAL FOR IDENTIFICATION. The form may request various identifying information from the individual including name, company affiliation, previously issued identifier or password specific to an awards program and other information. The individual must complete the form and press a command to cause the information to be transmitted by the browser across the network to the system. The information is received by the system and evaluated by the software program to determine whether the individual is an existing enrolled member. This step is indicated by decision block 1325, labeled IS INDIVIDUAL AN EXISTING ENROLLED MEMBER? The program determines if the individual is an existing enrolled member by comparing the information submitted by the individual with information contained in the database of existing members of the program. The information contained in the individual background profile in particular may be used for this determination.

If the program determines that the individual is not an existing enrolled member, the individual is offered the option of enrolling in the program. This step only takes place at this point if the individual has not previously completed the enrollment process. This may be done in any suitable manner. For example, a web-based form may be provided via the network to the client's browser and displayed for the individual. The form will have directions and blocks for providing valuable background information and for completing forms that are necessary to establish a unique individual background profile for the new program member. The individual's browser transmits that information across the network to the system. This step is indicated by block 1330, labeled INDIVIDUAL ENROLLS IN PROGRAM.

After determining that the individual is an existing enrolled member or after determining that an individual is not an existing enrolled member, but who then completes the enrollment process, the individual is directed to proceed to the next step of the process of logging on to a resource in order to engage in a time points earnings session. This step is the equivalent of the website identifying the individual, which would be indicated by the resource identifying the individual at the point of access, as noted above. This step is indicated by block 1335, labeled INDIVIDUAL LOGS ON TO RESOURCE. After this step or the step of the system in which the individual background profile of an individual is retrieved, the process proceeds to the step in which the individual conducts any necessary activity in order to initiate an accumulation session. For example, the individual may need to access a particular portion of a website in order to commence an accumulation session. This step is indicated by block 1340, labeled INDIVIDUAL TAKES STEPS TO INTIATE AN ACCUMULATION SESSION.

An accumulation session then commences, as indicated by block 1345, labeled ACCUMULATION SESSION TAKES PLACE. During this session, the individual is connected to the resource over the network. The computer software monitors the connection time of the individual and stores the information relative to the accumulation session that occurred during that period of connection time. This is indicated by block 1350, labeled, SYSTEM MONITORS AND STORES INFORMATION RELATIVE TO ACCUMULATION SESSION. The next step to occur in the process is the termination of the accumulation session. This may occur for reasons including: if the individual chooses to temporarily suspend the accumulation session, but fails to reinitiate the accumulation session as required by program or resource requirements; if the individual terminates the accumulation session, if the individual navigates to another website; if the individual disconnects from the network altogether; if the individual fails to respond to a prompt within a predetermined period of time applicable to the particular accumulation session; or if the individual chooses to temporarily suspend an accumulation session or by other means. The program then calculates the number of time points that were earned as a result of the accumulation session. Time points means any quantitative measure of an award calculated in part based on connection time of an earning session. Time points may be expressed in any suitable format, including a simple number, a duration of time, or in units of dollars or other currency. A formula, discussed in more detail below, is employed to calculate the award of time points based on various factors. These factors include the length of time of the earning session and/or the time of day when the earning session takes place. In addition, other information may be included in the formula. The formula includes consideration of the duration of connection time and other information and provides additional time points as an incentive for an individual to remain for a longer duration of connection time, in general, as well as in specific instances. The next step involving the calculation of time points is shown by block 1355, labeled CALCULATION OF NUMBER OF TIME POINTS EARNED. The calculation of the number of time points earned as a result of an accumulation session, is stored in a suitable location accessible by a database. The storing of the number of time points earned creates a time points account balance for the individual. The time points may be redeemed for something of value, or may have intrinsic value. In one aspect of the invention, the time points may be redeemed for goods, services, discounts, or money. In another aspect of the invention, in situations in which the attendance by an individual at a particular website is mandatory for a variety of reasons such as in the case of continuing legal education programs, the earned time points are of direct value since they are redeemed for a certificate of attendance reflecting satisfaction of applicable mandatory attendance requirements. The time points may be assigned intrinsic value; for example, a continuing education board may set a standard of a certain number of time points earned at its site or at accredited educational services providers' websites as fulfilling continuing education requirements. The individual may review account information and redeem time points as discussed above with reference to FIG. 1.

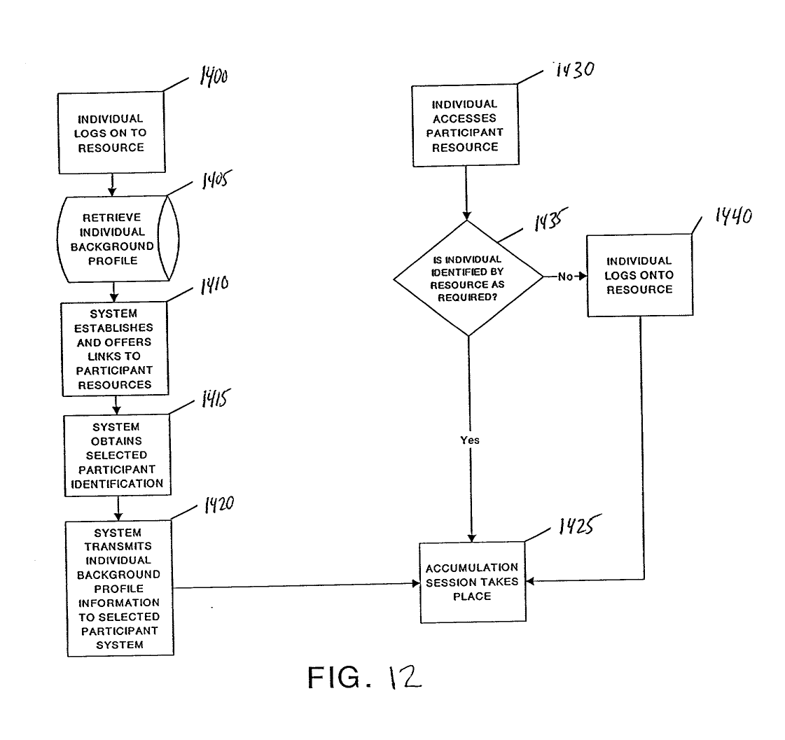

The accumulation session in the method and system related to connection to a resource will now be described with reference to FIG. 12. Referring now to FIG. 12, there is depicted a flow chart showing a process flow in a method of accumulating time points in connection with connection to an Internet resource. Referring to the branch of the process flow commencing with block 1400, there will be explained a process flow in which an individual links to a participant resource through a program administrator resource. The individual may be using a personal computer running a browser program that is connected to a website of the program administrator via the internet. Of course, other networks, systems, software and hardware may be used, as well. The first step of this part of the process involves having the individual log on to the program administrator's website, as indicated by block 1400, labeled INDIVIDUAL LOGS ON TO RESOURCE. By logging on to the program administrator's website, the individual must be identified by the system. The process of individual identification may be automatic, such as by identifying information in a cookie file that resides on the computer of the individual. The identification of an individual may also involve a log in process, the implementation of signature, handwriting, voice and other biometric identification technologies, various scanning technologies, as well as other security tools. In some variations of the invention, the identification process may be repeated at various times throughout the earning session so as to enable resources to confirm the specific identity of the individual in question, if necessary. For example, this feature may be employed in mandatory attendance settings as a method to ensure that the individual interacting with a website is present, attentive and adequately identified in accordance with resource requirements.

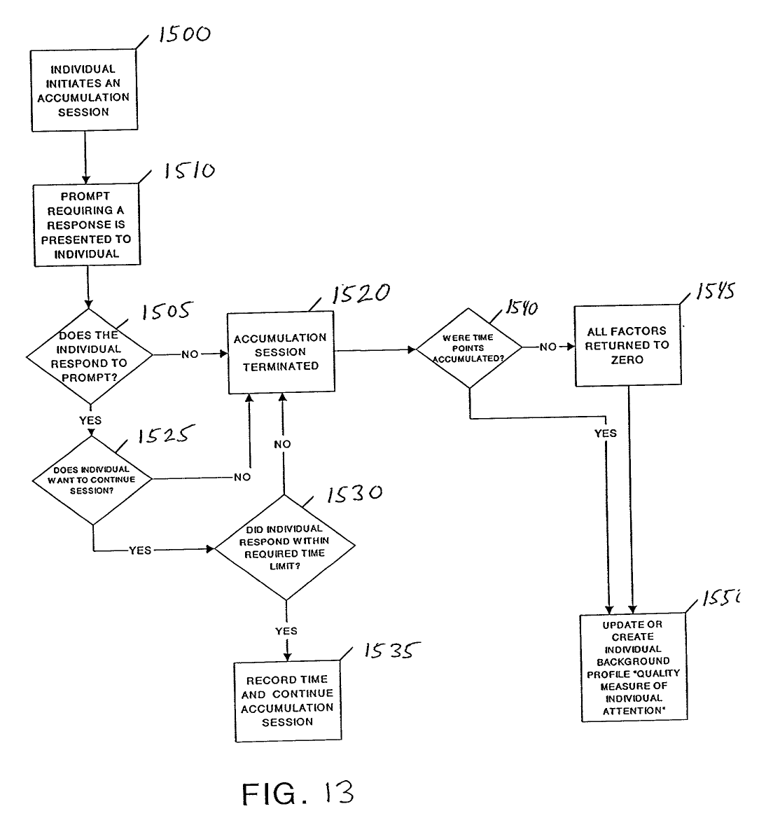

Upon receiving information from the individual, the program of the invention causes the system to retrieve the corresponding individual background profile from a database. This step is indicated by block 1405, labeled RETRIEVE INDIVIDUAL BACKGROUND PROFILE. The system then makes links available to various participant websites. For example, this may be accomplished by displaying information about various participant websites that offer content or products that match the known preferences and/or interests of the individual. This step is indicated by block 1410, labeled SYSTEM ESTABLISHES AND OFFERS LINKS TO PARTICIPANT RESOURCES. If the individual takes advantage of an available link to a participant website, the individual is immediately connected to that website. This connection may occur through a conventional hyperlink. The system monitors the identity of the participant website selected by the individual. This step is indicated by block 1415, labeled SYSTEM OBTAINS SELECTED PARTICIPANT IDENTIFICATION. The individual background profile corresponding to the individual is transmitted to the participant system. This step is indicated by block 1420, labeled SYSTEM TRANSMITS PROFILE INFORMATION TO SELECTED PARTICIPANT SYSTEM. The individual's system is then connected to the participant system at which point the individual may engage in an earning session as indicated by block 1425, labeled ACCUMULATION SESSION TAKES PLACE. The details of time points earnings sessions are further discussed in reference to FIG. 13 below.

Alternatively, the process flow may commence with an individual becoming connected to a participant resource, such as a website on the Internet. This is indicated by block 1430, labeled INDIVIDUAL ACCESSES PARTICIPANT RESOURCE. When an individual is detected, the software running on the system of the participant attempts to determine if the individual is adequately identified in accordance with resource requirements. This step is indicated by decision block 1435, labeled IS INDIVIDUAL IDENTIFIED BY RESOURCE AS REQUIRED? This step is carried out automatically, such as by reviewing items in a cookie file on the individual's computer. If the individual is identified in accordance with the applicable resource requirements, the process proceeds to the next step in the process. If not, then the participant's system offers the individual an opportunity to log in manually, such as through a web-based form. This step is indicated by block 1440, labeled INDIVIDUAL LOGS ON TO RESOURCE. If the information received from the individual is in accordance with applicable resource requirements, then the process flow proceeds to the actual accumulation session. If the information received from the individual is not in accordance with applicable resource requirements, then the individual will be unable to log in and to engage in an earning session.

Referring to FIG. 13, there is shown a process flow relating to an accumulation session in a method according to the invention. The specific period of connection time during which an accumulation session takes place is a period within the overall length of connection time recorded during a particular visit to a resource by an individual. The period of connection time during which an accumulation session takes place during a single, uninterrupted period of connection time is referred to as an accumulation session. The process flow commences with the recording of the results of the accumulation session in terms of time points accumulated, responses to sales offers, etc. This is indicated by block 1500, labeled INDIVIDUAL INITIATES AN ACCUMULATION SESSION. Upon commencement of an accumulation session by an individual, the system begins to track and record the length of the session, the nature of the activities that occur during the session, information or feedback that is obtained from an individual during the session and other relevant information. The information that is tracked may also include the data derived from the quality measure of individual attention performance results, as discussed below, demonstrated by the individual during accumulation sessions. In addition, the tracked information may include data relating to other tasks or activities in which individuals participate that resources may deem valuable, including the completion of forms and surveys, participation in real time conversations and interactions with sales representatives, participation in sales presentations, observation of special content that is presented to specific individuals for purposes of obtaining a wide range of feedback and for an endless variety of other reasons. Of course, the information that is generated as a result of an accumulation session is tracked, measured, rated in accordance with suitable algorithms and recorded. Additionally, individuals can be encouraged to navigate to a requested level within a resource such as a website; the resource may accomplish this by offering the individuals the opportunity to accumulate time points at a faster rate than at other locations within the resource. The resource may communicate information regarding the accumulation session in progress and related information to the individual in real time. For example, a meter may be provided in a window showing the number of time points accumulated/earned during the session, tasks completed, number of levels navigated and other factors that may affect the rate of accumulation of time points during a session. The window that contains the display may contain text messages and other advertising content designed to encourage individuals to engage in additional earning sessions.

According to the invention, the software program has a mandatory full screen function that, if preferred or desired by the resource, requires individuals who are engaged in an accumulation session to maintain a full screen for viewing the content in question. This feature is designed to ensure that the individual is actually exposed to the content that is presented and that individuals are not engaged in some other unrelated activity while they are simultaneously engaged in an accumulation session.

The quality measure of individual Attention feature is designed to measure, rate and record the level of attention that the individual demonstrates during accumulation sessions, if applicable. The quality measure of individual attention feature may be based upon some or all of a variety of factors that may be selected by participant websites. At a point during the accumulation session, the individual is offered a prompt that requires a response. This step in the process is described in decision block 1510 labeled PROMPT REQUIRING A RESPONSE IS PRESENTED TO INDIVIDUAL. During the accumulation session, if desired by the resource, the software program is designed to prompt the individual to provide a response in a specific way at various times throughout the earnings session. The prompts may be provided automatically on a random basis, at fixed or varying intervals, or the prompts may be provided after a pre-selected period of time during which no activity is detected by the resource. It is recognized that the lack of detectable activity may indicate that the individual is not paying attention to the content being presented at a resource website or, in fact, has left his or her computer or other device and is engaged in some other activity or is using an application program other than the browser connected to the participant's resource. It is also recognized that the lack of activity may be appropriate and expected under the particular circumstances at the particular resource. For example, an individual may be presented with a large block of text or a video that contains no interactive component. In that scenario, the prompts may take any form that may result in communicating an alert to the individual that an affirmative response is required in order to avoid a suspension or outright termination of the accumulation session. If an individual is devoting the degree of attention required by the particular resource, the termination of an earning session is easily avoided. Such prompts are preferably visual prompts so as to most effectively ensure that the individual is devoting a sufficient degree of attention to the content being presented to them by the resource so as to avoid the termination of the accumulation session. The prompts may include an icon that is present on the screen throughout the accumulation session that exists in a variety of states that are capable of being perceived visually. The first state may indicate that the accumulation session is in progress, a second state may indicate that the accumulation session is in progress but will terminate unless an affirmative response is received from the individual within a predetermined period of time and a third state may indicate that the accumulation session has been terminated. The second state may, in fact, be divided into several different types of states. In one variation, the state of the icon may indicate a warning that little time remains to respond to a prompt so as to avoid early termination of the accumulation session. In another variation, the icon may indicate how much time has elapsed since the second state had commenced, or how much time remains to respond before the third state commences. In the third state, the participant resource would have options of resuming an accumulation session once an appropriate, required form of input has been received by the resource, either with or without a deduction of previously accumulated time points due to the occurrence of the termination of the accumulation session. The third state is entered only after the second state has been displayed for a pre-determined, measured period of time during which the individual has failed to respond as required by the resource. By way of example, an icon in the form of a traffic signal with green, yellow and red lights may be presented. The first state may be represented by the illumination of the green light only, the second state may by represented by the illumination of the yellow light only and the third state may be represented by the illumination of the red light only. The second state of illumination may be divided into additional variations. In one variation, the icon may indicate a warning that the time within which to meet the applicable response requirements to displayed prompts is about to expire. The second state may be divided into various types of states. One state is the steady illumination of a yellow light. The other state is a yellow light that blinks at varying rates. For example, as the time within which to provide a response in order to avoid a suspension of the accumulation session approaches, the yellow light may blink at an increasingly faster rate so as to highlight the need for a response to be provided by the individual in a subtle, yet effective fashion. Individuals are instructed that an input is required within a certain period of time after the signal turns from green to yellow in order to continue the accumulation session. The system may track, measure and record the length of time between the point at which the prompt is first presented and the point at which a required form of response is actually received from the individual. That measured period of time may be employed as a factor in calculating the quality measure of individual attention of an individual. For example, if an individual consistently responds quickly to prompts from resources during accumulation sessions, that individual may receive a high quality measure of individual attention rating. Alternatively, if it consistently takes an individual a longer period of time to respond to prompts as required or desired by resources, then it is concluded that the particular individual has demonstrated a lower degree of attention to the resource and, thus, is assigned a lower quality measure of individual attention rating. Alternatively, there may be a minimum time threshold imposed by the resource that requires that an individual provide a response to a prompt, but not before a certain period of time has passed or else there may be no benefit associated with providing a response more quickly. The many variations as to how individuals must respond to prompts in order to demonstrate an acceptable degree of attention in order to continue with an accumulation session are resource-specific. For instance, a minimum time threshold may required that an individual provide a specific, required response to a prompt, but not before a period of time has passed, at which time it may be communicated for a limited period of time that a response is required, after which the display of the message indicating that a response is required may be discontinued. This will require that the individual remain alert for a request to provide a response to confirm individual presence and attention as required, after which the indication and opportunity to respond is removed as an option and this information is captured for later consideration. This will avoid the temptation by individuals to simply watch the icon without paying adequate attention to the content presented by the resource. The icon may also take a variety of forms other than a traffic signal. For example, the icon may be a moving icon in the first state for a pre-determined period of time, which stops in the second state, or it may be a stationary icon in the first state, which becomes a moving icon in the second state. In any case, the required response may be in the form of a variety of affirmative acts by the individual such as using a mouse to click on the icon or another specific portion of the screen, writing a signature on a pad or device, or any other response that may be communicated by the individual through the browser to the website or in some other fashion. The icon may be a light that remains steadily illuminated in the first state, then blinks in the second state, perhaps at various rates to indicate subdivisions of the second state, and finally ceases to be illuminated at all in the third state. The prompt may also be in the form of a text message requesting the individual to respond with specific information including responses to questions regarding the content that the individuals were supposed to be viewing or by proceeding to another page as instructed by the resource, text messages requesting verification of knowledge or understanding such as by presenting one or more questions in a form with multiple possible responses, a request for a specific voice interaction such as by speaking into a microphone at the remote location of the individual, a request for signature verification or a request for other biometric identifying information and by other methods of verifying the presence and/or attention of the individual. Thus, a particular acceptable response may be required. In addition to having an effect upon the rate of accumulation in the present session itself, this information may be calculated as an additional factor that affects whether the individual will be offered future opportunities to engage in accumulation sessions at that particular resource and throughout the entire network, as well as the rate at which the individual may accumulate additional time points during future accumulation sessions. This factor may be regarded as a quality measure of individual attention rating. The length of time that it takes for an individual to provide an acceptable form of response to a prompt from the resource is stored as part of the individual background profile of that individual. It will be understood that the specific correlation between the length of time that it takes to receive an adequate response and a numeric quality measure of individual attention will be based on initial estimates of average time of response rates and updated based on data accumulated over time. The expected average time of response rates may be adjusted depending on the content being viewed, information contained in the individual background profile, or other information. As noted below, the quality of responses returned within the acceptable time period may also be recorded. The quality of responses may be employed in calculating the quality measure of individual attention. In reference to FIG. 13-, the process flow continues with a prompt presented to the individual that requires a specific response, as indicated by block 1510 labeled PROMPT REQUIRING A RESPONSE IS PRESENTED TO INDIVIDUAL. The next steps to occur in the process flow depend upon whether the individual provides an acceptable response to a prompt during the accumulation session. This is indicated by block 1505 labeled DOES THE INDIVIDUAL RESPOND TO PROMPT? If not, then the accumulation session is terminated, as indicated by block 1520, labeled ACCUMULATION SESSION TERMINATED. If the individual does respond to a prompt as required by the resource, a prompt may be provided at this point, asking the individual to indicate whether the individual wishes to continue, as indicated by block 1525, labeled DOES INDIVIDUAL WANT TO CONTINUE ACCUMULATION SESSION? This prompt may be provided at other points in the process flow as well. The prompt may be configured either to require a response to continue the session, or to require a response to terminate the session. The next step to occur in the process flow depends upon whether the individual indicates a desire to continue the session. If the response, or lack thereof, indicates that the individual desires to terminate the session, the process proceeds to termination of the accumulation session. If the response (or lack thereof) indicates that the individual wishes to continue, the next step to occur in the process flow depends on whether the individual has provided an acceptable response within the required time limit, as indicated by block 1530, labeled DID INDIVIDUAL RESPOND WITHIN REQUIRED TIME LIMIT? If not, the process flow proceeds to terminate the accumulation session. If an acceptable response is detected within the pre-determined time limit imposed by the resource where the accumulation session takes place, the system records the length of time between the point in time when the prompt was first offered and the point in time when the acceptable response was received from the individual. This step is indicated by block 1535, labeled RECORD RESPONSE TIME AND CONTINUE ACCUMULATION SESSION. The system may have designated more than one response as sufficient or necessary to continue the accumulation session. However, the various responses may be recorded, and assigned different values in calculating the credits that are accumulated and/or earned. A first response may result in the outright termination of the accumulation session. A second response may result in a higher accumulation of credits, during the accumulation session. A third response may result in an even higher low Variations in the number of possible responses are possible. For example, a multiple choice question with three possible answers may be presented. A first answer may indicate that the individual is not paying adequate attention, and result in the outright termination of the accumulation session. A second answer may indicate that the individual is paying an intermediate level of attention and may have an effect upon the rate of accumulation of credits during a particular accumulation session and future ones, as well. A third answer may indicate that the individual is paying a high level of attention and would be credited accordingly. Of course, variations in the nature of the prompt and of the possible responses are possible. The ability to distinguish between and among various responses is referred to as distinguishing the quality of the response of the individual.

When the accumulation session is eventually terminated, the process flow proceeds to determine whether the formula requirements that were pre-selected by the resource have been met so as to result in the individual earning some or all of the time points that they had an opportunity to accumulate. The calculated number of time points that the individual is determined to have earned as a result of an accumulation session may depend on whether the accumulation session is terminated due to the failure by an individual to respond to a prompt within the time required to do so, and in the fashion required by the resource, as well. The calculation process may result in individuals failing to earn any time points as a result of an accumulation session if pre-determined requirements have not been met by the individual during the accumulation session, such as if the accumulation session is terminated prematurely due to individual inattention. This step is shown by decision block 1540, labeled WERE TIME POINTS ACCUMULATED? If not, then, as indicated by block 1545, which is labeled ALL FACTORS RETURNED TO ZERO, all factors such as the length of the session, the time of day of the session and others that may have been tentatively calculated or that have an existing accumulated assigned value that otherwise would have been credited to the individual are returned to zero for that individual. In addition, the quality measure of individual attention rating will be adjusted to reflect the results of the performance of the individual as a result of the time points accumulation session. If this is the first time that an individual has engaged in a time points accumulation session, a quality measure of individual attention is created and updated to reflect the activity in the just-completed accumulation session. This is indicated by block 1550, labeled UPDATE OR CREATE INDIVIDUAL BACKGROUND PROFILE AND “QUALITY MEASURE OF INDIVIDUAL ATTENTION”.

As an alternative following termination of the accumulation session, the individual may be afforded the opportunity to resume the accumulation session before calculation of time points totals. The software of the invention may wait for a predetermined time following termination before calculation. The individual may provide a response sufficient to continue the accumulation session after the time limit has expired, but within the predetermined time following termination. The accumulation session then resumes. The fact that the session was resumed may result in a lower total of time points or credits earned than for a session that was not terminated and resumed. The length of time from the termination of the session to the resumption may also be a factor in calculating the time points or credits earned for that accumulation session.

As a further option following an accumulation session that is terminated for failure to respond, the individual may be given the opportunity to review the content again, with the incentive that the terminated accumulation session will not be employed in recalculating and updating the quality measure of individual attention. This option will provide an incentive for the individual to review the content again, as a lowered quality measure of individual attention rating may result in lower awards of time points in the future. If the individual elects to start a new accumulation session, and the new accumulation session is completed, then the quality measure of individual attention rating will be calculated without reference to the prior accumulation session that was terminated due to the failure of the individual to respond to a prompt. Optionally, the sole incentive for the individual to engage in a new accumulation session may be the opportunity to recalculate the quality measure of individual attention without the negative effect associated with the accumulation session that was terminated due to inattention; for example, no time points or credits may be earned for some part or all of the new accumulation session. The availability of the option and opportunity to avoid the consequences associated with an occasional accumulation session that is terminated prematurely due to extended inattention is likely to generate and enhance the degree of goodwill individuals toward the system of the invention

An accumulation session may be conducted using audio communications only. For example, an accumulation session may be conducted by an individual using a telephone device to a computer system which is providing prepared audio programming. Connections to live programming may also be provided. For example, some portion of the accumulation session may be spent listening to a pre-recorded presentation that may contain a password or other information that the individual must present in order to be able to continue at a later point when specific feedback is requested. If the proper response is not received, the accumulation session may be terminated, or the number of points actually earned or available to be earned may be decreased. The response may be in the form of spoken words or phrases that are recognized by voice recognition technology, or by having the individual press appropriate buttons on a telephone keypad. If the accumulation session is terminated due to inattention, the individual may then be transferred immediately to a live operator. An accumulation session may also be provided that includes a pre-recorded portion, or a live presentation to numerous individuals, with a portion that includes live one-on-one interaction with a live sales operator. For example, the majority of an accumulation session may be pre-recorded, and, if responses to prompts reflect that the individual is being attentive or inattentive, the individual may then be transferred to a live human operator for such purposes as closing a sale. It will be understood that the techniques of the invention may be employed in an audio-only context, including the use of prompts, periodic messages to notify individuals of points accumulated, achievement of redemption thresholds, and the calculation of a quality measure of individual attention.

The invention has been described with respect to an exemplary method and system, but variations within the scope and spirit of the invention will be apparent to those of skill in the art, and the invention is not limited to any exemplary method or system described above.

What is claimed is:

1. A method of providing a rewards program, comprising the steps of:
making content available to an individual;
tracking attention of the individual to the content; and
providing rewards to the person based at least in part on the tracked attention.

2. The method of claim 1, wherein the content comprises a live presentation.

3. The method of claim 2, wherein the live presentation is presented at a physical commerce location.

4. The method of claim 2, wherein the live presentation is made to a single individual.

5. The method of claim 4, wherein during the live presentation a live presenter records quality of attention information.

6. The method of claim 5, wherein the quality of attention information includes recording commencement of an interruption in attention.

7. The method of claim 1, wherein the content comprises a recorded presentation comprising an audio portion.

8. The method of claim 7, wherein the audio portion is delivered via telephone.

9. The method of claim 7, wherein the audio portion is delivered via broadcast.

10. The method of claim 1, wherein the content comprises a recorded presentation comprising a text portion.

11. The method of claim 10, wherein the individual responds to prompts indicating comprehension of the content to indicate tracked attention.

12. A method for providing a rewards program, comprising the steps of:
receiving identification information relating to an individual at a physical commerce location provided by an individual who is present at the physical commerce location;
correlating received identification information with stored identification information;
recording the time of receipt of identification information;
calculating an award of credits based at least in part on a correlation between the time of receipt of identification information and predetermined time criteria relating to the award of credits.

13. The method of claim 12, further wherein said step of calculating comprises calculating an award of points based in part on other activities conducted by the individual while at the physical commerce location subsequent to identification.

14. The method of claim 12, further comprising the step of receiving identification information a plurality of occasions over a period of time from the individual at the physical commerce location, defining an accumulation session from the first receipt of identification to a final receipt of identification within prescribed time parameters, and calculating the credits at least in part on the basis of the duration of the accumulation session.

15. The method of claim 14, further comprising the step of, prior to said step of receiving identification information on at least one additional time within prescribed parameters, furnishing the individual with recorded information, and reading the recorded information substantially simultaneously with said step of receiving identification information a second time.

16. The method of claim 15, wherein the recorded information pertains to one or more purchase transactions made by the individual during the accumulation session.

17. The method of claim 15, wherein the recorded information pertains to one or more presentations attended by the individual during the accumulation session.

18. The method of claim 14, wherein the credits are calculated at least in part based on the recorded information.

19. The method of claim 18, wherein the credits may be calculated based on the duration of the accumulation session, purchase transactions made by the individual during the accumulation session, and tasks completed and presentations attended by the individual during the accumulation session.

20. A method for providing a rewards program, comprising the steps of: receiving identification information relating to an individual in connection with an event; recording information relating to the time of the event, correlating received identification information with stored identification information; calculating an award based at least in part on a correlation between the time of the event and predetermined time criteria.

21. The method of claim 20, wherein the award is contingent on future events involving the individual.

22. The method of claim 20, further comprising the step of, prior to said step of receiving identification information, furnishing the individual with recorded information, and reading the recorded information substantially simultaneously with said step of receiving identification information a second time.

23. The method of claim 20, wherein the event is a bill payment, and the recorded information includes information pertaining to a length of time before a due date the bill payment occurs.

24. The method of claim 23, wherein the reward comprises an entry in a drawing.

25. The method of claim 24, wherein rewards further comprise enhanced prizes for winning in the drawing.

26. The method of claim 23, wherein the reward further comprises enhanced likelihood of winning in a drawing.

27. The method of claim 23, wherein the reward may be redeemed only after a plurality of bill payments meeting specified timeliness criteria.

28. The method of claim 20, further comprising the step of receiving and recording information relating to a second type of event performed by the individual, and adjusting the calculation of the award based on the information relating to the second type of event.

29. The method of claim 20, wherein the event is a scheduled appointment.

30. The method of claim 20, wherein the event is a use of an item available for rental.

31. A method for providing an incentive to an individual for engaging in a desirable activity, comprising the steps of:
Recording the information relating to the desirable activity conducted by the individual,
Permitting the individual to enter a lottery, and
Basing one or more of the number of chances to participate in the lottery, the likelihood of winning, or the size or nature of the prize, on the recorded information.

32. The method of claim 31, wherein the desirable activity is the payment of periodic bills prior to the due date.

33. A method of providing a rewards program comprises the steps of:
enrolling an individual in a rewards program by obtaining individual profile information and storing said information at a program administrator location maintained by a program administrator;
requiring identification of the individual at a physical commerce location maintained by a program participant, the identification being based on said stored information;
commencing an accumulation session following the identification of the individual;
recording information, including at least the time of day, day of week and information pertaining to purchases made at the physical commerce location during the accumulation session;
forwarding said recorded information to the program administrator;
updating the stored individual profile information at the program administrator location;
calculating the time points accumulated as a result of the accumulation session based on the stored individual profile information and a formula selected by the program participant; and
permitting redemption of earned time points for items of value.

34. The method of claim 33, wherein a threshold value of time points is required to redeem a reward, and further comprising the step of notifying the individual when the threshold is achieved.

35. The method of claim 33, wherein the individual is notified during an accumulation session of the time points required in addition to those that would be accumulated if the accumulation session was immediately terminated to reach a threshold.

36. A method of identifying customers for enhanced customer service at physical commerce locations includes identifying individual customers upon entry into the physical commerce location based on information contained in a customer database;
determining for each of the identified customers the one of at least two categories of customers to which the individual has been assigned;
communicating to store personnel an indication of the category to which at which some of the identified customers have been assigned; and
furnishing differential levels of customer service to different customers depending upon the specific category to which a customer has been assigned and communicated to the store personnel.

37. The method of claim 36, wherein the step of communicating comprises furnishing information for each identified customer on a substrate, including indicia indicating the category to which the customer has been assigned, the indicia being visible from a reasonable distance if the individual is holding the substrate.

38. The method of claim 37, wherein the indicia comprises the color of at least a portion of the substrate.

39. The method of claim 37, wherein the substrate has printed thereon information concerning special offers available at the physical commerce location, whereby only customers in a specified category are made aware of said special offers.

40. The method of claim 36, wherein at least one of the categories is a preferred category, and the step of furnishing differential levels of customer service comprises providing customer assistance to individuals assigned to the preferred category in a more timely fashion.

41. A system of providing a rewards program comprises:
means for receiving from an individual, identification information upon entry into a physical commerce location;
means for correlating received identification information with stored identification information;
means for commencing an accumulation session;
means for monitoring the tasks and activities accomplished during the accumulation session;
means for calculating time points accumulated specific to the accumulation session, based at least in part on increasing numbers of time points accumulated based on increasing the length of time of the accumulation session.

42. A system for providing a rewards program comprises:
means for enrolling an individual in a rewards program by obtaining individual profile information and storing said information at a program administrator location;
means for identifying the individual at a physical commerce location administered by a participant, the identification being based on said stored information;
means for commencing an accumulation session following identification of the individual;
means for recording information, including at least the time of day, the day of week and the duration of the accumulation session, at the participant's location;
means for forwarding the recorded information to the program administrator;
means for updating the stored individual information at the administrator location with the forwarded recorded information;
means for calculating the time points accumulated or earned as a result of the accumulation session based on the stored individual information and a formula selected by the participant; and
means to permit the redemption of the earned time points for items of value.

43. A storage medium, having stored therein a plurality of instructions, is provided wherein the plurality of instructions, when executed by a processor, cause the processor to perform the steps of:
receiving identification information following the entry of a customer into a physical commerce location;
correlating received identification information with stored identification information;
commencing an accumulation session;
terminating the accumulation session at the departure of the customer from the physical commerce location;
monitoring the length of time of the accumulation session;
calculating time points accumulated as a result of the accumulation session, based at least in part on awarding credits in increased amounts with increasing the length of the accumulation session.

44. A storage medium is provided, having stored therein a plurality of instructions, wherein the plurality of instructions, when executed by a processor, cause the processor to perform the steps of:
enrolling an individual in a rewards program by obtaining individual profile information and storing said information;
requiring identification of the individual after entry into a physical commerce location administered by a participant, the identification being based on said stored information;
commencing an accumulation session following identification of the individual;
receiving recorded information, including at least duration of an accumulation session at a physical commerce location;
updating the stored individual information based on said recorded information;
calculating time points accumulated by the individual as a result of the accumulation session based on the stored individual information and a formula selected by the participant; and
debiting the time points held by the individual based on redemption information.

45. A method for providing a rewards program comprises the steps of:
receiving identification information relating to an individual at a physical commerce location provided by an individual who is present at the physical commerce location;
correlating received identification information with stored identification information;
recording the time of receipt of identification information;
calculating an award of credits based at least in part on a correlation between the time of receipt of identification information and predetermined time criteria relating to the award of credits;
receiving identification information relating to the individual from a client upon the establishment of a connection between the client and a network resource;
correlating received identification information with stored identification information;
commencing an accumulation session;
monitoring the time of the accumulation session;
calculating time points accumulated in the accumulation session, based at least in part on increasing amounts of credits based upon increasing the duration of the accumulation session;
and adding the time points accumulated pertaining to the presence of the individual at the physical commerce location and the credits awarded based on the connection between the client and the network to a time points account associated with the individual.

46. A method of providing a rewards program comprises the steps of:
enrolling an individual in a rewards program by obtaining individual profile information and storing said information at a program administrator location maintained by a program administrator;
requiring identification of the individual at a physical commerce location maintained by a program participant, the identification being based on said stored information;
commencing a physical commerce location accumulation session following the identification of the individual;
recording physical commerce location information, including at least the time of day, day of week and information pertaining to purchases made at the physical commerce location during the physical commerce location accumulation session;
forwarding said recorded physical commerce location information to the program administrator;
updating the stored individual profile information at the program administrator location;
calculating number of time points accumulated as a result of the physical commerce location accumulation session based on the stored individual profile information and a formula selected by the program participant;
requiring identification of the individual once a connection to a participant resource has been established, the identification being based on said stored information;
commencing an on-line accumulation session following the identification of the individual;
recording on-line information, including at least the time of day, the day of the week and the duration of the on-line accumulation session, at a participant's location during the on-line accumulation session;
forwarding said on-line recorded information to the program administrator;
updating the stored individual information at the program administrator location;
calculating the number of time points accumulated as a result of the on-line accumulation session based on the stored individual information and a formula selected by the participant and
permitting redemption of the earned credits for items of value.
